(19) United States
(12) Patent Application Publication
(10) Pub. No.: US 2026/0169224 A1
(43) Pub. Date: Jun. 18, 2026

(54) RING RESONATOR, OPTICAL MODULATOR, LIGHT SOURCE DEVICE, DISTANCE MEASURING DEVICE, AND RESONATOR DEVICE

(71) Applicant: SONY SEMICONDUCTOR SOLUTIONS CORPORATION, Kanagawa (JP)

(72) Inventor: Haruhiko TERADA, Kanagawa (JP)

(73) Assignee: SONY SEMICONDUCTOR SOLUTIONS CORPORATION, Kanagawa (JP)

(21) Appl. No.: 19/127,650

(22) PCT Filed: Oct. 16, 2023
(86) PCT No.: PCT/JP2023/037361

§ 371 Date: May 6, 2025

(30) Foreign Application Priority Data
Nov. 29, 2022 (JP) 2022-189801

(51) Int. Cl. G02B 6/293; G01S 7/4911; G01S 17/32

(52) U.S. Cl. CPC G02B 6/29343; G01S 7/4911; G01S 17/32

(57) ABSTRACT

A main object of the present technology is to provide a resonator capable of increasing a group refractive index of an optical waveguide. A ring resonator according to the present technology includes a ring-shaped optical waveguide (RWG), and the optical waveguide has a photonic crystal structure (PCS). According to the ring resonator of the present technology, it is possible to provide a resonator capable of increasing the group refractive index of the optical waveguide.

### TECHNICAL FIELD

The technology according to the present disclosure (hereinafter also referred to as “the present technology”) relates to a ring resonator, an optical modulator, a light source device, a distance measuring device, and a resonator device.

### BACKGROUND ART

Conventionally, for example, a ring resonator used for an optical modulator or the like is known (see, for example, Patent Document 1). In the ring resonator, a resonance wavelength is determined by an optical path length of an optical waveguide (ring-shaped optical waveguide).

That is, the resonance wavelength of the ring resonator depends on the refractive index of the optical waveguide of the ring resonator.

### CITATION LIST

### Patent Document

### Patent Document 1: Japanese Patent Application Laid-Open No. 2019-62036

### SUMMARY OF THE INVENTION

### Problems to be Solved by the Invention

For example, Patent Document 1 does not mention anything about increasing the group refractive index of the optical waveguide of the ring resonator.

A main object of the present technology is to provide a ring resonator capable of increasing a group refractive index of an optical waveguide.

### Solutions to Problems

The present technology provides a ring resonator including:
a ring-shaped optical waveguide, in which the optical waveguide has a photonic crystal structure.

The present technology also provides an optical modulator including:
an optical waveguide;
a ring resonator optically coupled to the optical waveguide; and
a phase shifter provided in the ring resonator and/or the optical waveguide, in which
at least the ring resonator among the ring resonator and the optical waveguide has a photonic crystal structure.

In the optical modulator, the ring resonator and the optical waveguide may have a photonic crystal structure.

In the optical modulator, only the ring resonator of the ring resonator and the optical waveguide may have a photonic crystal structure.

In the optical modulator, the phase shifter may be provided in the ring resonator.

The optical modulator may include a plurality of the ring resonators.

In the optical modulator, the phase shifter may be provided in at least one ring resonator of the plurality of ring resonators.

In the optical modulator, the phase shifter may be provided in some ring resonators among the plurality of ring resonators, and the phase shifter may not be provided in the other ring resonators.

In the optical modulator, the phase shifter may not be provided in at least one ring resonator of the plurality of ring resonators.

The optical modulator may include a plurality of the optical waveguides.

The optical modulator may include a plurality of the ring resonators and a plurality of the optical waveguides, and each of the plurality of ring resonators may be optically coupled to at least two optical waveguides of the plurality of optical waveguides.

In the optical modulator, the optical waveguide may include a branch portion or a combining portion.

In the optical modulator, an end of the optical waveguide may be connected to an optical amplifier.

In the optical modulator, the phase shifter may be provided at a position of the optical waveguide between an optical coupling portion between the optical waveguide and the ring resonator and the optical amplifier.

In the optical modulator, a mirror may be provided at an end of the optical waveguide.

In the optical modulator, the mirror may be a Sagnac loop or a distributed Bragg reflector.

In the optical modulator, a Mach-Zehnder modulator may be provided in the optical waveguide.

In the optical modulator, in the photonic crystal structure, a pore of a photonic crystal may include an air gap or a material having a refractive index different from a refractive index of a waveguide portion.

The present technology also provides a light source device including:
an optical amplifier; and
an optical modulator to which light from the optical amplifier is incident, in which
the optical modulator includes:
an optical waveguide;
a ring resonator optically coupled to the optical waveguide; and
a phase shifter provided in the ring resonator and/or the optical waveguide, and
at least the ring resonator among the ring resonator and the optical waveguide has a photonic crystal structure.

The present technology also provides a distance measuring device including:
an optical amplifier;
an optical modulator to which light from the optical amplifier is incident; and
a light receiving unit that receives light reflected by an object via the optical modulator, in which
the optical modulator includes:
an optical waveguide;
a ring resonator optically coupled to the optical waveguide; and
a phase shifter provided in the ring resonator and/or the optical waveguide, and
at least the ring resonator among the ring resonator and the optical waveguide has a photonic crystal structure.

The present technology also provides a resonator device including:
an optical waveguide; and
a ring resonator optically coupled to the optical waveguide, in which
at least the ring resonator among the ring resonator and the optical waveguide has a photonic crystal structure.

### BRIEF DESCRIPTION OF DRAWINGS

FIG. 1 is a diagram schematically illustrating a planar configuration of an optical modulator according to Example 1 of a first embodiment of the present technology.

FIG. 2 is a diagram schematically illustrating a planar configuration of an optical modulator according to Example 2 of the first embodiment of the present technology.

FIG. 3 is a diagram schematically illustrating a planar configuration of an optical modulator according to Example 3 of the first embodiment of the present technology.

FIG. 4 is a diagram schematically illustrating a planar configuration of an optical modulator according to Example 4 of the first embodiment of the present technology.

FIG. 5 is a diagram schematically illustrating a planar configuration of an optical modulator according to Example 5 of the first embodiment of the present technology.

FIG. 6 is a diagram schematically illustrating a planar configuration of an optical modulator according to Example 6 of the first embodiment of the present technology.

FIG. 7 is a diagram schematically illustrating a planar configuration of an optical modulator according to Example 7 of the first embodiment of the present technology.

FIG. 8 is a diagram schematically illustrating a planar configuration of an optical modulator according to Example 8 of the first embodiment of the present technology.

FIG. 9 is a diagram schematically illustrating a planar configuration of an optical modulator according to Example 9 of the first embodiment of the present technology.

FIG. 10 is a diagram schematically illustrating a planar configuration of a light source device according to Example 1 of a second embodiment of the present technology.

FIG. 11 is a diagram schematically illustrating a planar configuration of a light source device according to Example 2 of the second embodiment of the present technology.

FIG. 12 is a diagram schematically illustrating a planar configuration of a light source device according to Example 3 of the second embodiment of the present technology.

FIG. 13 is a diagram schematically illustrating a planar configuration of a light source device according to Example 4 of the second embodiment of the present technology.

FIG. 14 is a diagram schematically illustrating a planar configuration of a light source device according to Example 5 of the second embodiment of the present technology.

FIG. 15 is a diagram schematically illustrating a planar configuration of a light source device according to Example 6 of the second embodiment of the present technology.

FIG. 16 is a diagram schematically illustrating a planar configuration of a light source device according to Example 7 of the second embodiment of the present technology.

FIG. 17 is a diagram schematically illustrating a planar configuration of a light source device according to Example 8 of the second embodiment of the present technology.

FIG. 18 is a diagram schematically illustrating a planar configuration of a light source device according to Example 9 of the second embodiment of the present technology.

FIG. 19 is a diagram schematically illustrating a planar configuration of a light source device according to Example 10 of the second embodiment of the present technology.

FIG. 20 is a diagram schematically illustrating a planar configuration of a light source device according to Example 11 of the second embodiment of the present technology.

FIG. 21 is a diagram schematically illustrating a planar configuration of a light source device according to Example 12 of the second embodiment of the present technology.

FIG. 22 is a diagram illustrating a configuration example of a Mach-Zehnder modulator.

FIG. 23 is a diagram schematically illustrating a planar configuration of a light source device according to Example 13 of the second embodiment of the present technology.

FIG. 24 is a diagram schematically illustrating a planar configuration of a light source device according to Example 14 of the second embodiment of the present technology.

FIG. 25 is a diagram schematically illustrating a planar configuration of a light source device according to Example 15 of the second embodiment of the present technology.

FIG. 26 is a diagram schematically illustrating a planar configuration of a light source device according to Example 16 of the second embodiment of the present technology.

FIG. 27 is a diagram schematically illustrating a planar configuration of a light source device according to Example 17 of the second embodiment of the present technology.

FIG. 28 is a block diagram illustrating a configuration example of a distance measuring device according to a third embodiment of the present technology.

FIG. 29 is a diagram schematically illustrating a planar configuration of a resonator device according to Example 1 of a fourth embodiment of the present technology.

FIG. 30 is a diagram schematically illustrating a planar configuration of a resonator device according to Example 2 of the fourth embodiment of the present technology.

FIG. 31 is a diagram schematically illustrating a planar configuration of a resonator device according to Example 3 of the fourth embodiment of the present technology.

FIG. 32 is a diagram schematically illustrating a planar configuration of a resonator device according to Example 4 of the fourth embodiment of the present technology.

FIG. 33 is a diagram schematically illustrating a planar configuration of a resonator device according to Example 5 of the fourth embodiment of the present technology.

FIG. 34 is a diagram schematically illustrating a planar configuration of a resonator device according to Example 6 of the fourth embodiment of the present technology.

FIG. 35 is a diagram schematically illustrating a planar configuration of a ring resonator according to a fifth embodiment of the present technology.

FIG. 36 is a diagram schematically illustrating an example of a cross-sectional configuration of a ring waveguide of an optical modulator according to Example 1 of the first embodiment of the present technology.

FIG. 37 is a diagram schematically illustrating an example of a cross-sectional configuration of a linear waveguide of the optical modulator according to Example 1 of the first embodiment of the present technology.

FIG. 38 is a diagram schematically illustrating another example of the cross-sectional configuration of the ring waveguide of the optical modulator according to Example 1 of the first embodiment of the present technology.

### MODE FOR CARRYING OUT THE INVENTION

Hereinafter, preferred embodiments of the present technology will be described in detail with reference to the accompanying drawings. Note that, in the present specification and drawings, components having substantially the same functional configuration are denoted by the same reference signs, and redundant description is omitted. The embodiments to be described below provide representative embodiments of the present technology, and the scope of the present technology is not to be narrowly interpreted according to those embodiments. In the present specification, even in a case where it is described that a ring resonator, an optical modulator, a light source device, a distance measuring device, and a resonator device according to the present technology exhibit a plurality of effects, the ring resonator, the optical modulator, the light source device, the distance measuring device, and the resonator device according to the present technology are only required to exhibit at least one effect. The effects described in the present specification are merely examples and are not limited, and other effects may be exerted.

Furthermore, the description will be given in the following order.

### 0. Introduction

1. Optical modulator according to Example 1 of first embodiment of present technology
2. Optical modulator according to Example 2 of first embodiment of present technology
3. Optical modulator according to Example 3 of first embodiment of present technology
4. Optical modulator according to Example 4 of first embodiment of present technology
5. Optical modulator according to Example 5 of first embodiment of present technology
6. Optical modulator according to Example 6 of first embodiment of present technology
7. Optical modulator according to Example 7 of first embodiment of present technology
8. Optical modulator according to Example 8 of first embodiment of present technology
9. Optical modulator according to Example 9 of first embodiment of present technology
10. Light source device according to Example 1 of second embodiment of present technology
11. Light source device according to Example 2 of second embodiment of present technology
12. Light source device according to Example 3 of second embodiment of present technology
13. Light source device according to Example 4 of second embodiment of present technology
14. Light source device according to Example 5 of second embodiment of present technology
15. Light source device according to Example 6 of second embodiment of present technology
16. Light source device according to Example 7 of second embodiment of present technology
17. Light source device according to Example 8 of second embodiment of present technology
18. Light source device according to Example 9 of second embodiment of present technology
19. Light source device according to Example 10 of second embodiment of present technology
20. Light source device according to Example 11 of second embodiment of present technology
21. Light source device according to Example 12 of second embodiment of present technology
22. Light source device according to Example 13 of second embodiment of present technology
23. Light source device according to Example 14 of second embodiment of present technology
24. Light source device according to Example 15 of second embodiment of present technology
25. Light source device according to Example 16 of second embodiment of present technology
26. Light source device according to Example 17 of second embodiment of present technology
27. Distance measuring device according to third embodiment of present technology
28. Resonator device according to Example 1 of fourth embodiment of present technology
29. Resonator device according to Example 2 of fourth embodiment of present technology
30. Resonator device according to Example 3 of fourth embodiment of present technology
31. Resonator device according to Example 4 of fourth embodiment of present technology
32. Resonator device according to Example 5 of fourth embodiment of present technology
33. Resonator device according to Example 6 of fourth embodiment of present technology
34. Ring resonator according to fifth embodiment of present technology
35. Modification of present technology

### <0. Introduction>

Conventionally, an optical modulator including a ring resonator and a phase shifter is known. This optical modulator is used as an optical modulation unit of a light source device such as a tunable mode-locked laser (hereinafter referred to as a “ring laser”). However, in this optical modulator, there is a problem that power consumption of the phase shifter necessary for changing the resonance wavelength of the ring resonator is large. Furthermore, the response speed of the phase shifter limits the rate of change in the resonance wavelength. For this reason, when the response speed of the phase shifter is slow, the speed of change of the resonance wavelength is slow, and there is a problem that the distance resolution is lowered in a case where the ring laser is used as a light source of frequency modulated continuous wave (FMCW) light detection and ranging (LiDAR), for example.

The wavelength of the ring laser changes according to the magnitude of the group refractive index (group index) of the ring resonator. More specifically, as the group refractive index of the ring resonator is higher, the resonance wavelength is more likely to change, the speed of the change in the resonance wavelength is increased (the response speed of the phase shifter is increased), and the power consumption of the phase shifter necessary for the change in the resonance wavelength can be reduced.

By the way, in a photonic crystal waveguide (PCW) in which pores are regularly formed in a Si layer, a group refractive index of an optical waveguide can be increased to several times or more of that of a normal Si fine wire waveguide by appropriately designing a shape, a diameter, and a pitch of each pore.

The inventor has succeeded in dramatically increasing the group refractive index of the ring resonator by introducing a photonic crystal structure into the ring resonator. Furthermore, the inventor has succeeded in reducing power consumption and improving distance resolution in a case where the optical modulator is used as an optical modulation unit of a light source device such as a ring laser used for FMCW, for example, by incorporating a ring resonator in which an optical waveguide includes a photonic crystal waveguide into the optical modulator. The present technology embodies the above novel idea.

Hereinafter, an optical modulator according to a first embodiment of the present technology will be described in detail with some examples.

<1. Optical Modulator according to Example 1 of First Embodiment of Present Technology>

Hereinafter, an optical modulator 10-1 according to Example 1 of the first embodiment of the present technology will be described. <<Configuration of optical modulator >>

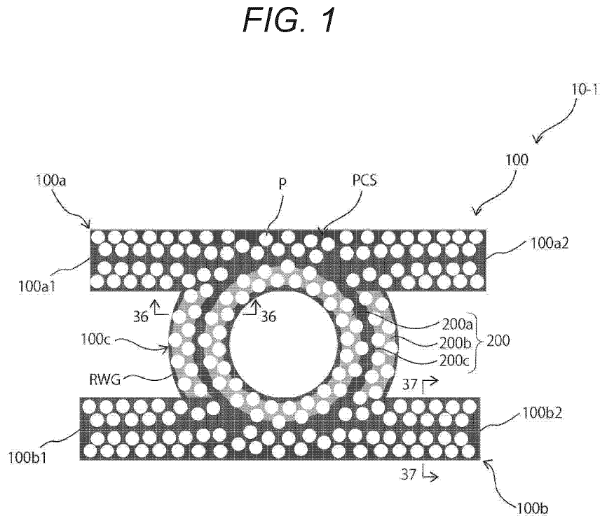

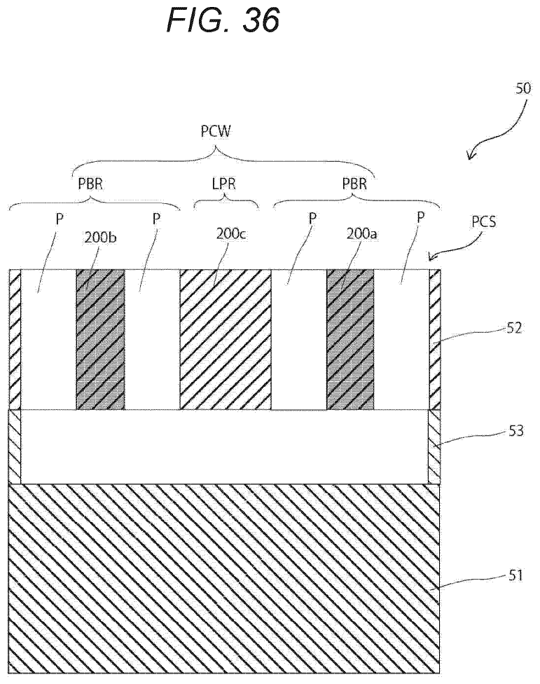

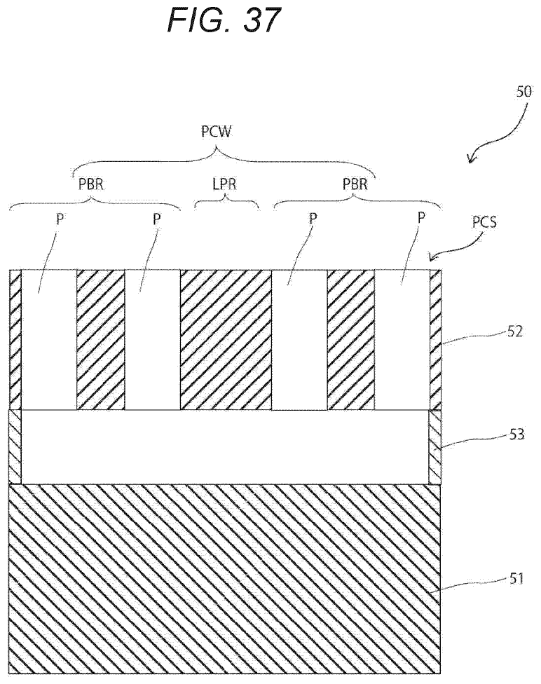

FIG. 1 is a diagram schematically illustrating a planar configuration of the optical modulator 10-1 according to Example 1 of the first embodiment of the present technology. FIG. 36 is a diagram schematically illustrating an example of a cross-sectional configuration of a ring waveguide of the optical modulator 10-1 according to Example 1 of the first embodiment of the present technology. FIG. 36 is a cross-sectional view taken along line 36-36 in FIG. 1. FIG. 37 is a diagram schematically illustrating an example of a cross-sectional configuration of a linear waveguide of the optical modulator 10-1 according to Example 1 of the first embodiment of the present technology. FIG. 37 is a cross-sectional view taken along line 37-37 in FIG. 1.

As an example, the optical modulator 10-1 is used as an optical modulation unit of a light source device of a distance measuring device (for example, in-vehicle LiDAR) adopting a frequency continuous modulation (FMCW) system.

As illustrated in FIG. 1, the optical modulator 10-1 includes first and second optical waveguides 100a and 100b, a ring resonator 100c optically coupled (optical coupling) to each of the first and second optical waveguides 100a and 100b, and a phase shifter 200 provided in the ring resonator 100c. The resonator device 100 includes the first and second optical waveguides 100a and 100b and the ring resonator 100c.

As an example, the optical modulator 10-1 is formed on a silicon on insulator (SOI) substrate 50 (see FIGS. 36 and 37). The SOI substrate 50 includes a Si substrate 51 and a Si layer 52 stacked on each other, and an insulator layer 53 existing between the Si substrate 51 and the Si layer 52. The Si layer 52 is a core layer of a ring-shaped optical waveguide (hereinafter also referred to as a “ring waveguide RWG”) included in the first and second optical waveguides 100a and 100b and the ring resonator 100c. The insulator layer 53 is a SiO₂ layer (sacrificial layer) including an air layer serving as a cladding layer of the first and second optical waveguides 100a and 100b and the ring waveguide RWG of the ring resonator 100c inside.

Returning to FIG. 1, each of the first and second optical waveguides 100a and 100b is a linear optical waveguide (hereinafter, also referred to as a “linear waveguide”) as an example. In the first optical waveguide 100a, one end 100a1 and/or the other end 100a2 can be an input/output port (input port or output port). The one end 100b1 and the other end 100b2 of the second optical waveguide 100b can be used as input/output ports (input ports or output ports).

The optical modulator 10-1 functions as a 2 to 4 port optical modulator.

Here, the first and second optical waveguides 100a and 100b and the ring resonator 100c are integrated in a state where the first and second optical waveguides 100a and 100b sandwich the ring resonator 100c from both sides in the radial direction. That is, each of the first and second optical waveguides 100a and 100b and the ring resonator 100c have an overlapping portion. The coupling efficiency (coupling efficiency) and the coupling length (length of the curved portion of the ring waveguide RWG causing a coupling phenomenon) between the ring resonator 100c and each linear waveguide are properly set (preferably optimized) by the overlapping portion.

In the optical modulator 10-1, the ring resonator 100c and each of the first and second optical waveguides 100a and 100b have a photonic crystal structure PCS. That is, the ring waveguide RWG of the ring resonator 100c and each of the first and second optical waveguides 100a and 100b include a photonic crystal waveguide PCW (see FIGS. 36 and 37) having a photonic crystal structure PCS. In the photonic crystal waveguide PCW, a core layer (Si layer 52) is sandwiched in the longitudinal direction by an air layer having a sufficiently lower refractive index than that of the core layer, so that optical confinement in the longitudinal direction is realized.

The photonic crystal structure PCS has a plurality of pores P (for example, circular pores) two-dimensionally arranged (periodic arrangement such as staggered arrangement or matrix arrangement) in the Si layer 52 of the SOI substrate 50. Each of the pores P may be an air gap or may be a material having a refractive index different from that of the waveguide portion (region in which light of each linear waveguide or the ring waveguide RWG propagates). As illustrated in FIGS. 36 and 37, the photonic crystal waveguide PCW is an optical waveguide (also referred to as a “line defect waveguide”) including, in the Si layer 52, photonic band gap regions PBR that are regions where the plurality of pores P are formed and prevent propagation of light of a specific wavelength band (for example, a wavelength band including a resonance wavelength of the ring resonator 100c) in an in-plane direction, and a light propagation region LPR (region where light propagates) that is a region where the pores P are not formed and is sandwiched between the photonic band gap regions PBR in the in-plane direction. That is, in the photonic crystal waveguide PCW, light confinement in the lateral direction (in-plane direction) is realized by the photonic band gap region PBR.

In the photonic crystal structure PCS, the shape, diameter, and pitch (period) of the pores P are set such that the group refractive index of the ring waveguide RWG and each linear waveguide is several times higher than that of a normal Si fine wire waveguide. However, the diameter and pitch (period) of the pores P need to be set so that the photonic band gap region PBR is formed.

The phase shifter 200 includes a first semiconductor region 200a provided on the inner peripheral portion of the ring waveguide RWG of the ring resonator 100c, a second semiconductor region 200b provided on the outer peripheral portion, and a third semiconductor region 200c located between the first and second semiconductor regions 200a and 200b. Each of the first and second semiconductor regions 200a and 200b includes a p-type or n-type semiconductor (Si). The third semiconductor region 200c includes an i-type semiconductor (Si). The first to third semiconductor regions 200a, 200b, and 200c can constitute a thermo-optical phase shifter having any conductivity type of p-i-p, p-i-n, and n-i-n. The thermo-optical phase shifter as the phase shifter 200 has a heater that heats the ring waveguide RWG. By controlling the heating temperature of the heater, the refractive index of the ring waveguide RWG can be changed to modulate the resonance wavelength of the ring resonator 100c. The heater is provided, for example, along the ring waveguide RWG.

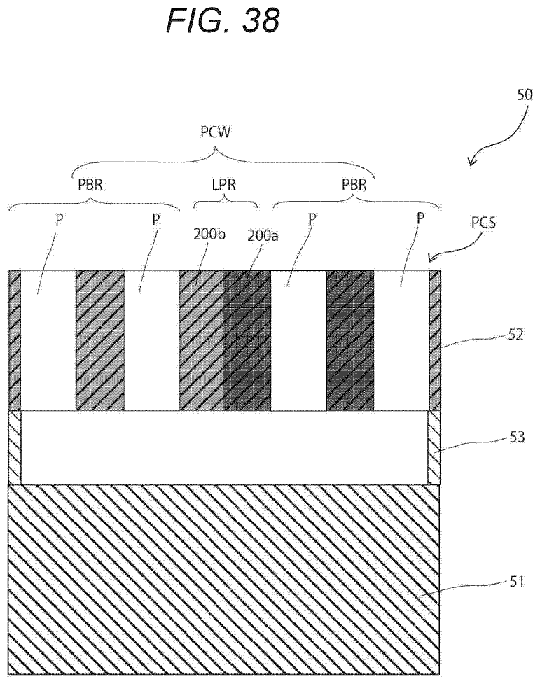

Note that a pn carrier plasma type phase shifter can also be configured by forming one of the first and second semiconductor regions 200a and 200b as a p-type semiconductor region and the other as an n-type semiconductor region, and joining the first and second semiconductor regions 200a and 200b to form a pn junction (see FIG. 38 which is a cross-sectional view corresponding to FIG. 36). The pn carrier plasma type phase shifter as the phase shifter 200 can change the refractive index of the ring waveguide RWG and modulate the resonance wavelength of the ring resonator 100c by controlling the carrier density of the pn junction by the applied voltage.

### <<Operation of Optical Modulator>>

An operation of the optical modulator 10-1 will be described below. An optical amplifier (for example, a laser) is optically connected to one end 100a1 (referred to as an input port) of the first optical waveguide 100a (photonic crystal waveguide). Among the light output from the optical amplifier and incident from the input port, the light having the same wavelength as the resonance wavelength of the ring resonator 100c propagates to the ring resonator 100c in the coupling region (optical coupling portion) between the first optical waveguide 100a and the ring resonator 100c. The light propagated to the ring resonator 100c passes through the inside of the ring waveguide RWG (photonic crystal waveguide) while being wavelength-modulated by the phase shifter 200 provided in the ring waveguide RWG. For example, the light that has passed through the ring waveguide RWG and propagated to the first optical waveguide 100a in the coupling region (optical coupling portion) between the first optical waveguide 100a and the ring resonator 100c can be output from the other end 100a2 (referred to as an output port) of the first optical waveguide 100a. For example, the light that has passed through the ring waveguide RWG and propagated to the second optical waveguide 100b (photonic crystal waveguide) in the coupling region (optical coupling portion) between the second optical waveguide 100b and the ring resonator 100c can be output from the one end 100b1 (referred to as an output port) of the second optical waveguide 100b. In the optical modulator 10-1, the series of operations described above is continuously performed, and the resonance wavelength of the ring resonator 100c can be modulated (increased or decreased) at high speed and low power consumption by the action of the ring resonator 100c having the photonic crystal waveguide and the phase shifter 200 provided in the ring resonator 100c. As a result, a chirp signal as an optical signal can be output from the output port in an extremely short period.

Note that, in the optical modulator 10-1, even in a case where, in place of the one end 100a1 of the first optical waveguide 100a, any of the other end 100a2 of the first optical waveguide 100a, the one end 100b1 of the second optical waveguide 100b, and the other end 100b2 is used as an input port, and wavelength-modulated light (optical signal) can be output from at least one port.

### <<Effects of Optical Modulator>>

Hereinafter, effects of the optical modulator 10-1 according to Example 1 of the first embodiment of the present technology will be described. The optical modulator 10-1 includes the first and second optical waveguides 100a and 100b, the ring resonator 100c optically coupled to each of the first and second optical waveguides 100a and 100b, and the phase shifter 200 provided in the ring resonator 100c, and the ring resonator 100c and the first and second optical waveguides 100a and 100b have the photonic crystal structure PCS.

In this case, since the group refractive index of the optical waveguide (ring waveguide RWG) of the ring resonator 100c can be increased, the power consumption necessary for the change in the resonance wavelength of the phase shifter 200 can be reduced, and the speed of the change in the resonance wavelength by the phase shifter 200 can be increased. The fact that the speed of wavelength change by the phase shifter 200 can be increased leads to improvement of distance resolution in a ring laser used for FMCW, for example.

Since the ring resonator 100c and the first and second optical waveguides 100a and 100b have the photonic crystal structure PCS, the insertion loss generated in the optical coupling portion (coupling region) between the ring waveguide RWG and each linear waveguide can be reduced. This leads to an improvement in light emission efficiency of the ring laser, for example.

The optical modulator 10-1 has a plurality of optical waveguides (first and second optical waveguides 100a and 100b) optically coupled with the ring resonator 100c. In this case, one end of one end and the other end of each of the first and second optical waveguides 100a and 100b can be an input port, and at least one other end can be an output port.

<2. Optical Modulator according to Example 2 of First Embodiment of Present Technology>

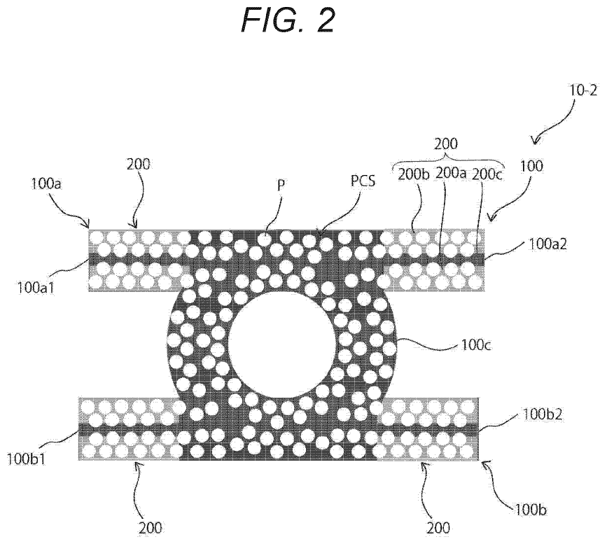

Hereinafter, an optical modulator 10-2 according to Example 2 of the first embodiment of the present technology will be described. FIG. 2 is a diagram schematically illustrating a planar configuration of the optical modulator 10-2 according to Example 2 of the first embodiment of the present technology.

As illustrated in FIG. 2, the optical modulator 10-2 has a configuration similar to the optical modulator 10-1 according to Example 1 except that the phase shifter 200 is provided at each end (portion of each linear waveguide that is different from an overlapping portion of the linear waveguide and the ring waveguide) of the first and second optical waveguides 100a and 100b. Note that the phase shifter provided in the linear waveguide is different in shape from, for example, the phase shifter provided in the ring resonator of the optical modulator 10-1, but has the same configuration and function, and thus is denoted by the same reference numeral 200 (this similarly applies hereinafter).

In the optical modulator 10-2, for example, when the one end 100al of the first optical waveguide 100a is set as an input port, the center wavelength of the input light can be shifted (for example, matched with the resonance wavelength) within the wavelength band including the resonance wavelength of the ring resonator 100c by the phase shifter 200 provided at the end including the one end 100a1. For example, when the other end 100a2 of the first optical waveguide 100a and the one end 100b1 of the second optical waveguide 100b are set as output ports, the phase shifters 200 provided at the end including the other end 100a2 and the end including the one end 100b1 can modulate the wavelength of light having the same wavelength as the resonance wavelength via the ring resonator 100c. Therefore, the optical modulator 10-2 can substantially modulate the resonance wavelength at a high speed and with low power consumption. At least two phase shifters 200 may be synchronously controlled in the optical modulator 10-2.

Note that, in the optical modulator 10-2, the phase shifters 200 are provided at two ends (total of four ends) of each of the first and second optical waveguides 100a and 100b, but are not limited thereto, and are preferably provided at least at an end including an output port. As the phase shifter 200 is increased, the degree of freedom and stability of modulation can be improved, but on the other hand, power and light loss increase. In consideration of this, it is desirable to select the input port and the output port and determine the number and arrangement of the phase shifters 200.

<3. Optical Modulator according to Example 3 of First Embodiment of Present Technology>

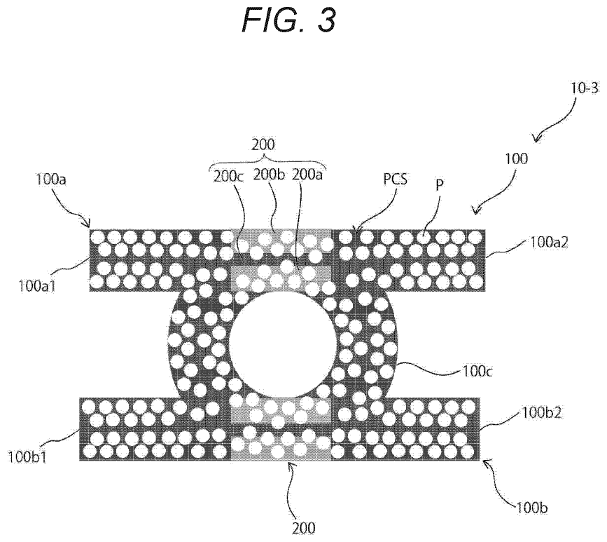

Hereinafter, an optical modulator 10-3 according to Example 3 of the first embodiment of the present technology will be described. FIG. 3 is a diagram schematically illustrating a planar configuration of the optical modulator 10-3 according to Example 3 of the first embodiment of the present technology.

As illustrated in FIG. 3, the optical modulator 10-3 has a configuration similar to the optical modulator 10-1 according to Example 1 except that the phase shifter 200 is provided at an overlapping portion between each of the first and second optical waveguides 100a and 100b and the ring resonator 100c.

The optical modulator 10-3 can also substantially modulate the resonance wavelength at high speed and with low power consumption.

Note that, in the optical modulator 10-3, the phase shifter 200 is provided in an overlapping portion between each of the first and second optical waveguides 100a and 100b and the ring resonator 100c, but may be provided only in an overlapping portion between one of the first and second optical waveguides 100a and 100b and the ring resonator 100c.

<4. Optical Modulator according to Example 4 of First Embodiment of Present Technology>

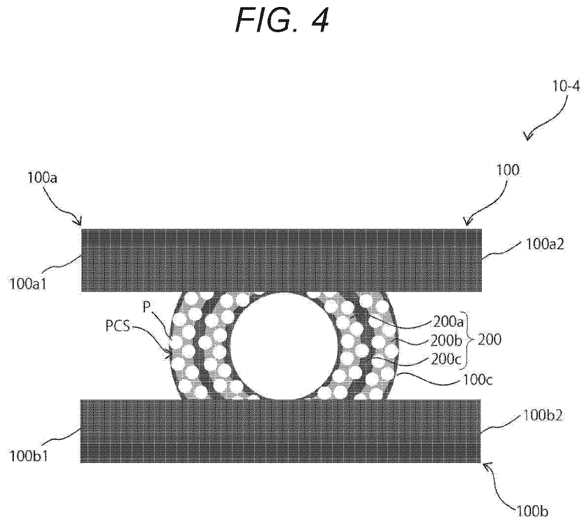

Hereinafter, an optical modulator 10-4 according to Example 4 of the first embodiment of the present technology will be described. FIG. 4 is a diagram schematically illustrating a planar configuration of the optical modulator 10-4 according to Example 4 of the first embodiment of the present technology.

As illustrated in FIG. 4, the optical modulator 10-4 has a configuration similar to the optical modulator 10-1 according to Example 1 except that each of the first and second optical waveguides 100a and 100b does not have the photonic crystal structure PCS.

In the optical modulator 10-4, the first and second optical waveguides 100a and 100b realize optical confinement in the lateral direction and the longitudinal direction by a refractive index difference between a Si layer as a core layer and air around the Si layer.

Note that, in the optical modulator 10-4, the ring resonator 100c and one of the first and second optical waveguides 100a and 100b may have the photonic crystal structure PCS.

<5. Optical Modulator according to Example 5 of First Embodiment of Present Technology>

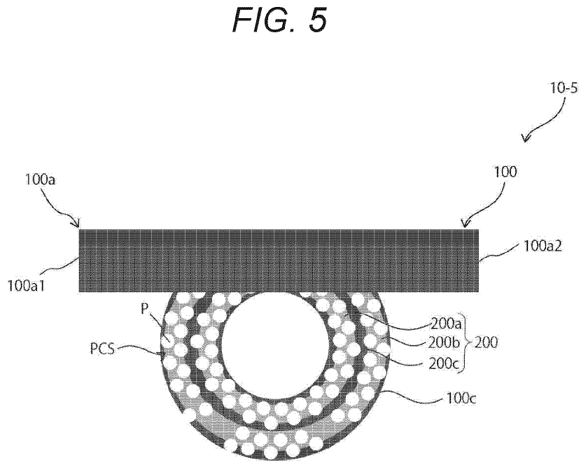

Hereinafter, an optical modulator 10-5 according to Example 5 of the first embodiment of the present technology will be described. FIG. 5 is a diagram schematically illustrating a planar configuration of the optical modulator 10-5 according to Example 5 of the first embodiment of the present technology.

As illustrated in FIG. 5, the optical modulator 10-5 has a configuration similar to the optical modulator 10-4 according to Example 4 except that the second optical waveguide 100 b is not included.

In the optical modulator 10-5, the first optical waveguide 100a realizes optical confinement in the lateral direction and the longitudinal direction by a refractive index difference between a Si layer as a core layer and air around the Si layer.

In the optical modulator 10-5, for example, light having the same wavelength as the resonance wavelength of the ring resonator 100c among light input from the one end 100al (referred to as an input port) of the first optical waveguide 100a propagates to the ring resonator 100c at the optical coupling portion between the first optical waveguide 100a and the ring resonator 100c. The light propagated to the ring resonator 100c passes through the inside of the ring resonator 100c while being wavelength-modulated by the phase shifter 200 provided in the ring resonator 100c, and is propagated to the first optical waveguide 100a at an optical coupling portion between the ring resonator 100c and the first optical waveguide 100a. The light propagated to the first optical waveguide 100a is output from the other end 100a2 (referred to as an output port) of the first optical waveguide 100a.

Note that, in the optical modulator 10-5, the first optical waveguide 100a may have the photonic crystal structure PCS.

<6. Optical Modulator according to Example 6 of First Embodiment of Present Technology>

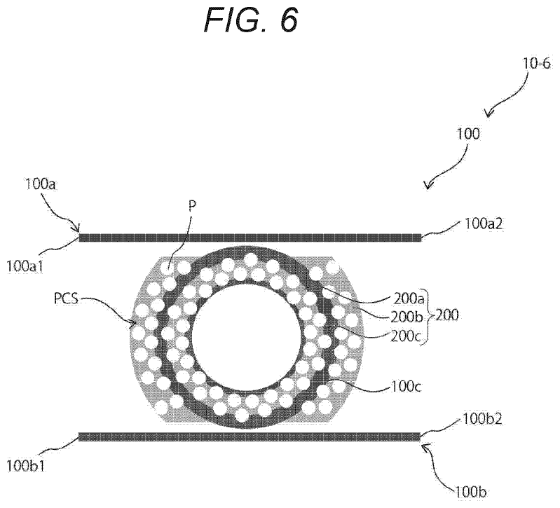

Hereinafter, an optical modulator 10-6 according to Example 6 of the first embodiment of the present technology will be described. FIG. 6 is a diagram schematically illustrating a planar configuration of the optical modulator 10-6 according to Example 6 of the first embodiment of the present technology.

As illustrated in FIG. 6, the optical modulator 10-6 has a configuration substantially similar to that of the optical modulator 10-1 according to Example 1 except that each of the first and second optical waveguides 100a and 100b and the ring resonator 100c are arranged apart from each other so as to be optically couplable (there is no overlapping portion).

In the optical modulator 10-6, each linear waveguide includes a Si fine wire waveguide, and the linear waveguide realizes optical confinement in the lateral direction and the longitudinal direction by a refractive index difference between a Si layer as a core layer and air around the Si layer. The distance between each linear waveguide and the ring waveguide is set such that the coupling efficiency and the coupling length (length of the curved portion of the ring waveguide causing a coupling phenomenon) between the linear waveguide and the ring resonator 100c are properly set (preferably optimized).

Since each of the first and second optical waveguides 100a and 100b and the ring resonator 100c are separated from each other, the optical modulator 10-6 is relatively easily manufactured.

<7. Optical Modulator according to Example 7 of First Embodiment of Present Technology>

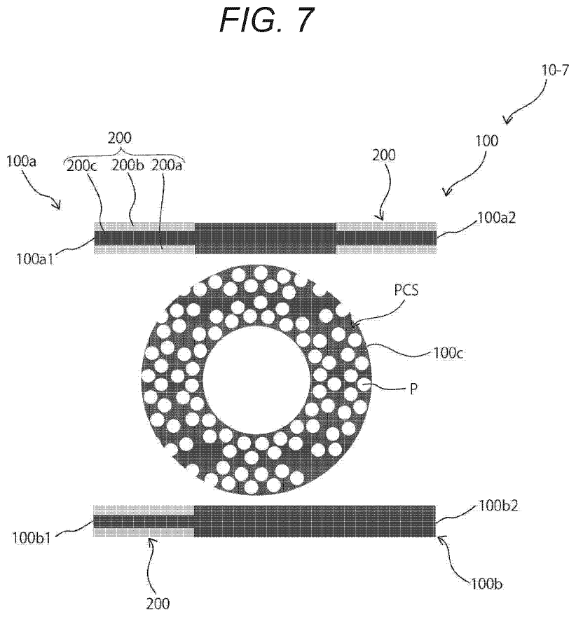

Hereinafter, an optical modulator 10-7 according to Example 7 of the first embodiment of the present technology will be described. FIG. 7 is a diagram schematically illustrating a planar configuration of the optical modulator 10-7 according to Example 7 of the first embodiment of the present technology.

The optical modulator 10-7 has a configuration substantially similar to the optical modulator 10-6 according to Example 6 except that the phase shifter 200 is not provided in the ring resonator 100c and the phase shifter 200 is provided in each of the first and second optical waveguides 100a and 100b.

In the optical modulator 10-7, in each linear waveguide, optical confinement in the lateral direction and the longitudinal direction is realized by a refractive index difference between a Si layer as a core layer and air around the Si layer. The distance between each linear waveguide and the ring waveguide is set such that the coupling efficiency and the coupling length (length of the curved portion of the ring waveguide causing a coupling phenomenon) between the linear waveguide and the ring resonator 100c are properly set (preferably optimized).

Note that, in the optical modulator 10-7, the phase shifter 200 may be provided only near the output port of at least one of the first and second optical waveguides 100a and 100b.

<8. Optical Modulator according to Example 8 of First Embodiment of Present Technology>

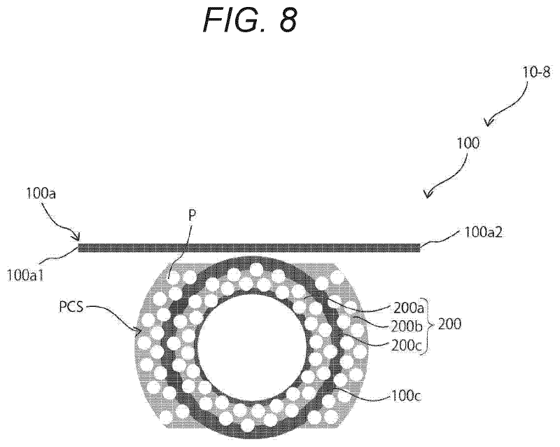

Hereinafter, an optical modulator 10-8 according to Example 8 of the first embodiment of the present technology will be described. FIG. 8 is a diagram schematically illustrating a planar configuration of the optical modulator 10-8 according to Example 8 of the first embodiment of the present technology.

The optical modulator 10-8 has a configuration similar to the optical modulator 10-6 according to Example 6 except that the second optical waveguide 100 b is not included.

In the optical modulator 10-8, the Si fine wire waveguide serving as the linear waveguide realizes optical confinement in the lateral direction and the longitudinal direction by a refractive index difference between the Si layer serving as the core layer and air around the Si layer. The distance between the linear waveguide and the ring waveguide is set such that the coupling efficiency and the coupling length (length of the curved portion of the ring waveguide causing a coupling phenomenon) between the linear waveguide and the ring resonator 100c are properly set (preferably optimized).

<9. Optical Modulator according to Example 9 of First Embodiment of Present Technology>

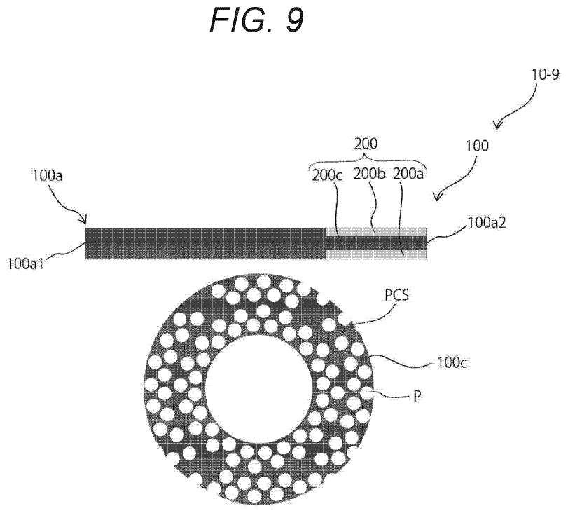

Hereinafter, an optical modulator 10-9 according to Example 9 of the first embodiment of the present technology will be described. FIG. 9 is a diagram schematically illustrating a planar configuration of the optical modulator 10-9 according to Example 9 of the first embodiment of the present technology.

The optical modulator 10-9 has a configuration substantially similar to the optical modulator 10-7 according to Example 7 except that the second optical waveguide 100 b is not included.

In the optical modulator 10-9, the linear waveguide realizes optical confinement in the lateral direction and the longitudinal direction by a refractive index difference between a Si layer as a core layer and air around the Si layer. The distance between the linear waveguide and the ring waveguide is set such that the coupling efficiency and the coupling length (length of the curved portion of the ring waveguide causing a coupling phenomenon) between the linear waveguide and the ring resonator 100c are properly set (preferably optimized).

Note that, in the optical modulator 10-9, the phase shifter 200 is provided only at the end including the other end 100a2 of the first optical waveguide 100a, but in addition to or instead of this, the phase shifter 200 may be provided at the end including the one end 100al of the first optical waveguide 100a and/or an intermediate portion of the first optical waveguide 100a.

<10. Light Source Device according to Example 1 of Second Embodiment of Present Technology>

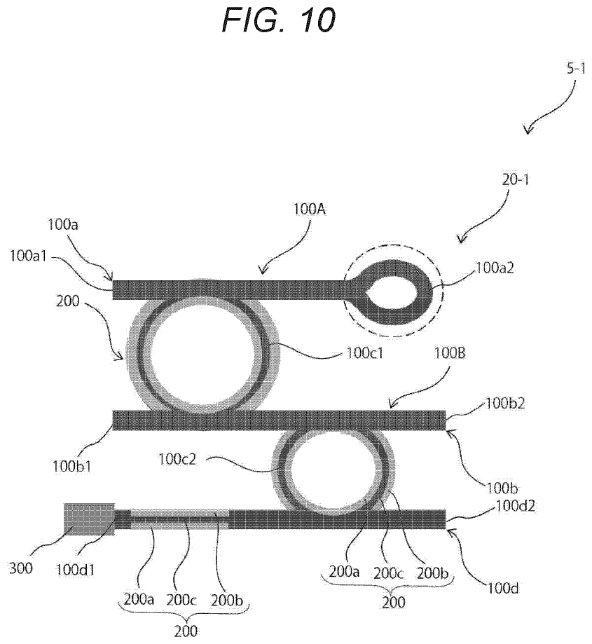

Hereinafter, a light source device according to Example 1 of the second embodiment of the present technology will be described. FIG. 10 is a diagram schematically illustrating a planar configuration of a light source device 5-1 according to Example 1 of the second embodiment of the present technology.

The light source device 5-1 includes an optical amplifier 300 and an optical modulator 20-1 into which light from the optical amplifier 300 is incident.

The optical modulator 20-1 includes first to third optical waveguides 100a, 100b, and 100d and first and second ring resonators 100c1 and 100c2. The first to third optical waveguides 100a, 100b, and 100d are linear waveguides (for example, Si fine wire waveguides). Here, the at least one linear waveguide and/or the at least one ring waveguide is a photonic crystal waveguide PCW having a photonic crystal structure PCS (see FIGS. 36 to 38).

The first ring resonator 100c1 is optically coupled to the first and second optical waveguides 100a and 100b. Here, the first and second optical waveguides 100a and 100b arranged in parallel sandwich the first ring resonator 100c1 in the in-plane direction (for example, the radial direction). The first resonator device 100A includes the first and second optical waveguides 100a and 100b and the first ring resonator 100c1. Note that at least one of the first and second optical waveguides 100a and 100b and the first ring resonator 100c1 may be separated from each other so as to be optically couplable.

The second ring resonator 100c2 is optically coupled to the second and third optical waveguides 100b and 100d. Here, the second and third optical waveguides 100b and 100d arranged in parallel sandwich the second ring resonator 100c2 in the in-plane direction (for example, the radial direction). A second resonator device 100B includes the second and third optical waveguides 100b and 100d and the second ring resonator 100c2. The second ring resonator 100c2 is arranged at a position shifted from the first ring resonator 100cl with respect to the direction in which each linear waveguide extends. Note that at least one of the second and third optical waveguides 100b and 100d and the second ring resonator 100c2 may be separated from each other so as to be optically couplable.

The first and second ring resonators 100c1 and 100c2 may have the same resonance wavelength or different resonance wavelengths. A phase shifter 200 is provided in each of the first and second ring resonators 100c1 and 100c2.

In the optical modulator 20-1, a Sagnac loop (portion surrounded by a broken line in FIG. 10) as a mirror is provided at an end including the other end 100a2 of the first optical waveguide 100a. Note that, as the mirror, another mirror element such as a distributed Bragg reflector may be provided instead of the Sagnac loop.

As the optical amplifier 300, for example, a reflective semiconductor optical amplifier (RSOA), a distributed feedback (DFB) laser, a surface emitting laser, an end surface emitting laser, or the like can be used.

An end including one end 100d1 of the third optical waveguide 100d is connected to the optical amplifier 300.

The second ring resonator 100c2 is optically coupled to a portion of the third optical waveguide 100d between the one end 100d1 and the other end 100d2. A phase shifter 200 is provided at a position of the third optical waveguide 100d between the optical amplifier 300 and an optical coupling portion of the third optical waveguide 100d and the second ring resonator 100c2.

In the light source device 5-1, the light output from the optical amplifier 300 to the third optical waveguide 100d can be wavelength-modulated and output from at least one of the one end 100a1 of the first optical waveguide 100a, the one end 100b1 and the other end 100b2 of the second optical waveguide 100b, and the other end 100d2 of the third optical waveguide 100d via at least the second ring resonator 100c 2 of the first and second ring resonators 100c1 and 100c2. At this time, it is preferable to synchronously control the phase shifter 200 provided in the third optical waveguide 100d and the phase shifter 200 provided in each of the first and second ring resonators 100c1 and 100c2. Thereby, continuous wavelength modulation without a mode hop can be performed.

In the light source device 5-1, the spectral linewidth reduction effect can be obtained by the vernier effect by the first and second ring resonators 100c1 and 100c2.

<11. Light Source Device according to Example 2 of Second Embodiment of Present Technology>

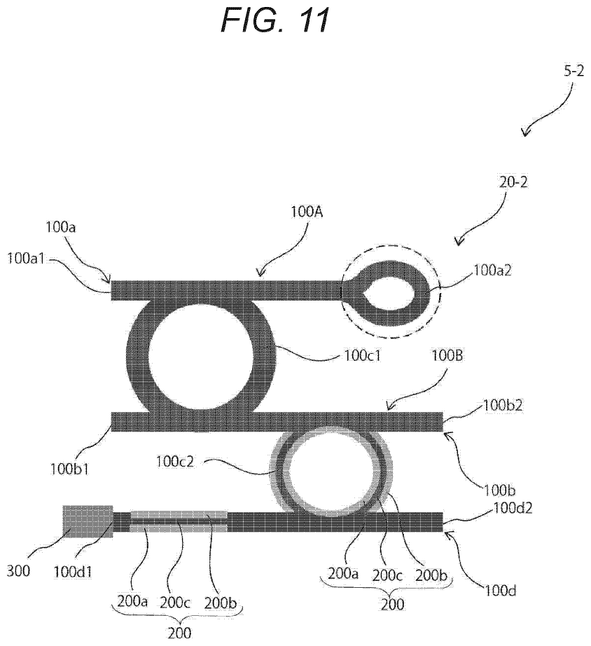

Hereinafter, a light source device according to Example 2 of the second embodiment of the present technology will be described. FIG. 11 is a diagram schematically illustrating a planar configuration of a light source device 5-2 according to Example 2 of the second embodiment of the present technology.

The light source device 5-2 has a configuration similar to the light source device 5-1 according to Example 1 except that the phase shifter 200 is not provided in a first ring resonator 100c1 of an optical modulator 20-2.

<12. Light Source Device according to Example 3 of Second Embodiment of Present Technology>

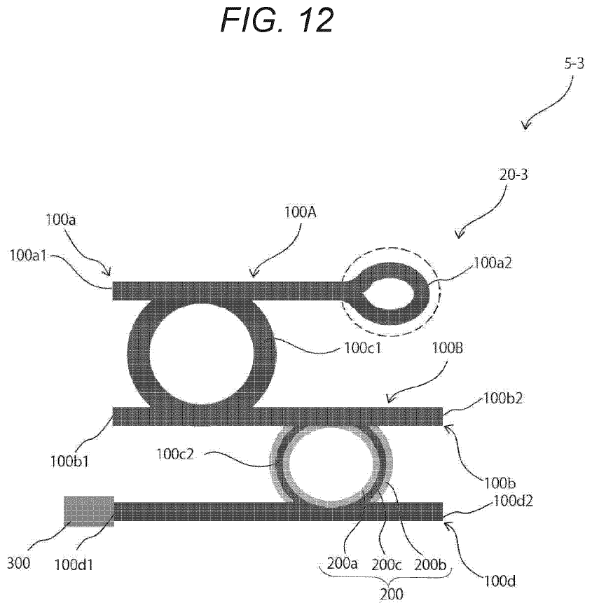

Hereinafter, a light source device according to Example 3 of the second embodiment of the present technology will be described. FIG. 12 is a diagram schematically illustrating a planar configuration of a light source device 5-3 according to Example 3 of the second embodiment of the present technology.

The light source device 5-3 has a configuration similar to the light source device 5-2 according to Example 2 except that the phase shifter 200 is not provided in a third optical waveguide 100d of an optical modulator 20-3.

<13. Light Source Device according to Example 4 of Second Embodiment of Present Technology>

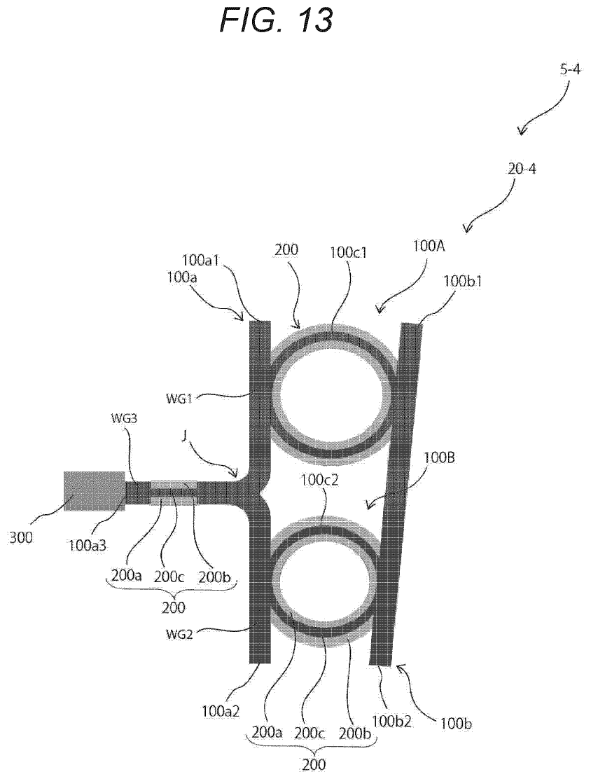

Hereinafter, a light source device according to Example 4 of the second embodiment of the present technology will be described. FIG. 13 is a diagram schematically illustrating a planar configuration of a light source device 5-4 according to Example 5 of the second embodiment of the present technology.

The light source device 5-4 includes an optical amplifier 300 and an optical modulator 20-4 into which light from the optical amplifier 300 is incident.

The optical modulator 20-4 includes first and second optical waveguides 100a and 100b and first and second ring resonators 100c1 and 100c2.

The first optical waveguide 100a includes a connection portion J and three waveguide portions WG1, WG2, and WG3 connected via the connection portion J (branch portion or combining portion). In the waveguide portion WG3, one end (end 100a3 of the first optical waveguide 100a) is connected to the optical amplifier 300, the other end is connected to the two waveguide portions WG1 and WG2 at the connection portion J, and a phase shifter 200 is provided in a portion between the one end and the other end. One end of the waveguide portion WG1 is connected to the waveguide portion WG3 at the connection portion J. One end of the waveguide portion WG2 is connected to the waveguide portion WG3 at the connection portion J. Each waveguide portion is a linear waveguide (for example, a Si fine wire waveguide). Here, the connection portion J functions as a branch portion that branches the light output from the optical amplifier 300 and is guided by the waveguide portion WG3 into the two waveguide portions WG1 and WG2.

In the optical modulator 20-4, the second optical waveguide 100b is a linear waveguide (for example, a Si fine wire waveguide).

In the optical modulator 20-4, the at least one linear waveguide and/or the at least one ring waveguide is a photonic crystal waveguide PCW having a photonic crystal structure PCS (see FIGS. 36 to 38).

The first ring resonator 100cl is sandwiched between the waveguide portion WG1 and the second optical waveguide 100b in the in-plane direction. A first resonator device 100A includes the waveguide portion WG1, the second optical waveguide 100b, and the first ring resonator 100c1. At least one of the waveguide portion WG1 and the second optical waveguide 100b and the first ring resonator 100c1 may be separated from each other so as to be optically couplable.

The second ring resonator 100c2 is sandwiched between the waveguide portion WG2 and the second optical waveguide 100b in the in-plane direction. A second resonator device 100B includes the waveguide portion WG2, the second optical waveguide 100b, and the second ring resonator 100c2. At least one of the waveguide portion WG2 and the second optical waveguide 100b and the second ring resonator 100c2 may be separated from each other so as to be optically couplable.

In the optical modulator 20-4, the resonance wavelengths of the first and second ring resonators 100c1 and 100c2 may be the same or different.

As the optical amplifier 300, for example, a reflective semiconductor optical amplifier (RSOA), a distributed feedback (DFB) laser, a surface emitting laser (VCSEL), an end surface emitting laser, or the like can be used.

In the light source device 5-4, the light output from the optical amplifier 300 and guided through the waveguide portion WG3 can be wavelength-modulated and output from at least one of the other end of the waveguide portion WG1 (the one end 100a1 of the first optical waveguide 100a), the other end of the waveguide portion WG2 (the other end 100a2 of the first optical waveguide 100a), the one end 100b1 of the second optical waveguide 100b, and the other end 100b2 thereof via at least one of the first and second ring resonators 100c1 and 100c2. At this time, it is preferable to synchronously control the phase shifter 200 provided in the waveguide portion WG3 and the phase shifter 200 provided in each of the first and second ring resonators 100c1 and 100c2. Thereby, continuous wavelength modulation without a mode hop can be performed.

In the light source device 5-4, the spectral linewidth reduction effect can be obtained by the vernier effect by the first and second ring resonators 100c1 and 100c2.

<14. Light Source Device according to Example 5 of Second Embodiment of Present Technology>

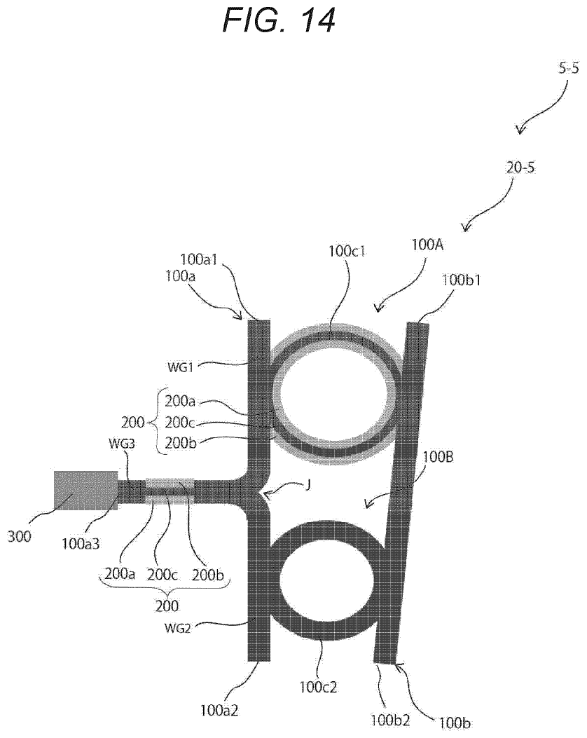

Hereinafter, a light source device according to Example 5 of the second embodiment of the present technology will be described. FIG. 14 is a diagram schematically illustrating a planar configuration of a light source device 5-5 according to Example 5 of the second embodiment of the present technology.

The light source device 5-5 has a configuration similar to the light source device 5-4 according to Example 4 except that the phase shifter 200 is not provided in a second ring resonator 100c2 of an optical modulator 20-5.

<15. Light Source Device according to Example 6 of Second Embodiment of Present Technology>

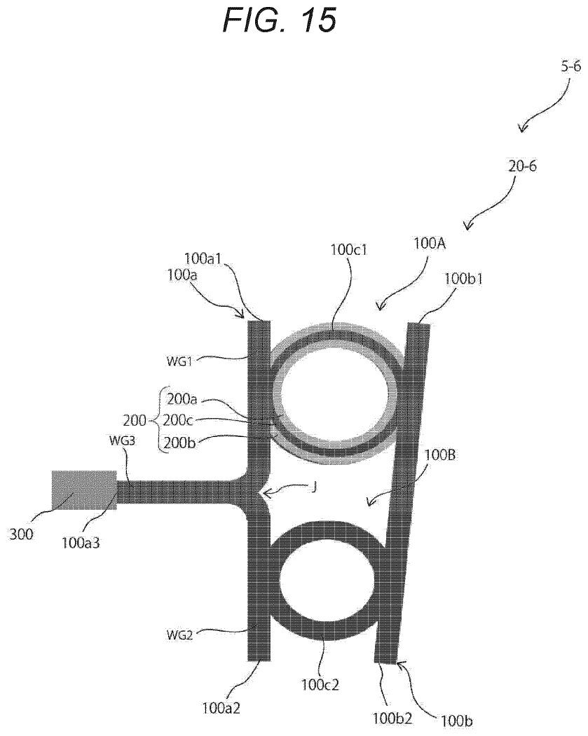

Hereinafter, a light source device according to Example 6 of the second embodiment of the present technology will be described. FIG. 15 is a diagram schematically illustrating a planar configuration of a light source device 5-6 according to Example 6 of the second embodiment of the present technology.

The light source device 5-6 has a configuration similar to the light source device 5-4 according to Example 4 except that the phase shifter 200 is not provided in a waveguide portion WG3 and a second ring resonator 100c2 of an optical modulator 20-6.

<16. Light Source Device according to Example 7 of Second Embodiment of Present Technology>

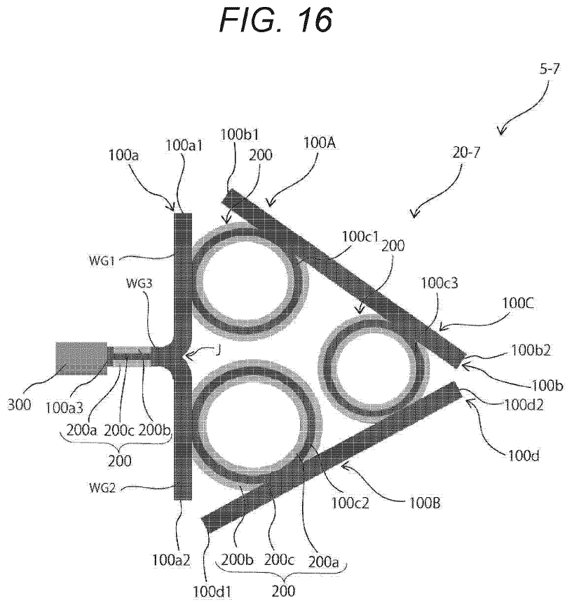

Hereinafter, a light source device according to Example 7 of the second embodiment of the present technology will be described. FIG. 16 is a diagram schematically illustrating a planar configuration of a light source device 5-7 according to Example 7 of the second embodiment of the present technology.

The light source device 5-7 includes an optical amplifier 300 and an optical modulator 20-7 into which light from the optical amplifier 300 is incident.

The optical modulator 20-7 includes first to third optical waveguides 100a, 100b, and 100c and first to third ring resonators 100c1, 100c2, and 100c3.

The first optical waveguide 100a includes three waveguide portions WG1, WG2, and WG3 connected via a connection portion J (branch portion or combining portion). In the waveguide portion WG3, one end (end 100a3 of the first optical waveguide 100a) is connected to the optical amplifier 300, the other end is connected to the waveguide portions WG1 and WG2 at the connection portion J, and a phase shifter 200 is provided in a portion between the one end and the other end. One end of the waveguide portion WG1 is connected to the waveguide portion WG3 at the connection portion J. One end of the waveguide portion WG2 is connected to the waveguide portion WG3 at the connection portion J. Each waveguide portion is a linear waveguide (for example, a Si fine wire waveguide). Here, the connection portion J functions as a branch portion that branches the light output from the optical amplifier 300 and is guided by the waveguide portion WG3 into the two waveguide portions WG1 and WG2.

Each of the second and third optical waveguides 100b and 100d is a linear waveguide (for example, a Si fine wire waveguide).

In the optical modulator 20-7, the at least one linear waveguide and/or the at least one ring waveguide is a photonic crystal waveguide PCW having a photonic crystal structure PCS (see FIGS. 36 to 38).

For example, the first ring resonator 100c1 is sandwiched between the waveguide portion WG1 and the second optical waveguide 100b arranged to form an acute angle in the in-plane direction. A first resonator device 100A includes the waveguide portion WG1, the second optical waveguide 100b, and the first ring resonator 100c1. At least one of the waveguide portion WG1 and the second optical waveguide 100b and the first ring resonator 100cl may be separated from each other so as to be optically couplable.

For example, the second ring resonator 100c2 is sandwiched between the waveguide portion WG2 and the third optical waveguide 100d arranged to form an acute angle in the in-plane direction. A second resonator device 100B includes the waveguide portion WG2, the third optical waveguide 100d, and the second ring resonator 100c2. At least one of the waveguide portion WG2 and the third optical waveguide 100d and the second ring resonator 100c2 may be separated from each other so as to be optically couplable.

For example, the third ring resonator 100c3 is sandwiched between the second and third optical waveguides 100b and 100d arranged so as to form an acute angle in the in-plane direction. A third resonator device 100C includes second and third optical waveguides 100b and 100d and a third ring resonator 100c3. At least one of the second and third optical waveguides 100b and 100d and the third ring resonator 100c3 may be separated from each other so as to be optically couplable.

In the optical modulator 20-7, at least two resonance wavelengths of the first to third ring resonators 100c1, 100c2, and 100c3 may be the same or different.

As the optical amplifier 300, for example, a reflective semiconductor optical amplifier (RSOA), a distributed feedback (DFB) laser, a surface emitting laser (VCSEL), an end surface emitting laser, or the like can be used.

In the light source device 5-7, the light output from the optical amplifier 300 and guided through the waveguide portion WG3 can be wavelength-modulated and output from at least one of the other end of the waveguide portion WG1 (the one end 100al of the first optical waveguide 100a), the other end of the waveguide portion WG2 (the other end 100a2 of the first optical waveguide 100a), the one end 100b1 and the other end 100b2 of the second optical waveguide 100b, and the one end 100d1 and the other end 100d2 of the third optical waveguide 100d via at least one of the first to third ring resonators 100c1, 100c2, and 100c3 and at least one of the first and second ring resonators 100c1 and 100c2. At this time, it is preferable to synchronously control the phase shifter 200 provided in the waveguide portion WG3 and the phase shifter 200 provided in each of the first to third ring resonators 100c1, 100c2, and 100c3. Thereby, continuous wavelength modulation without a mode hop can be performed.

In the light source device 5-7, the spectral linewidth reduction effect can be obtained by the vernier effect by the first to third ring resonators 100c1, 100c2, and 100c3.

<17. Light Source Device according to Example 8 of Second Embodiment of Present Technology>

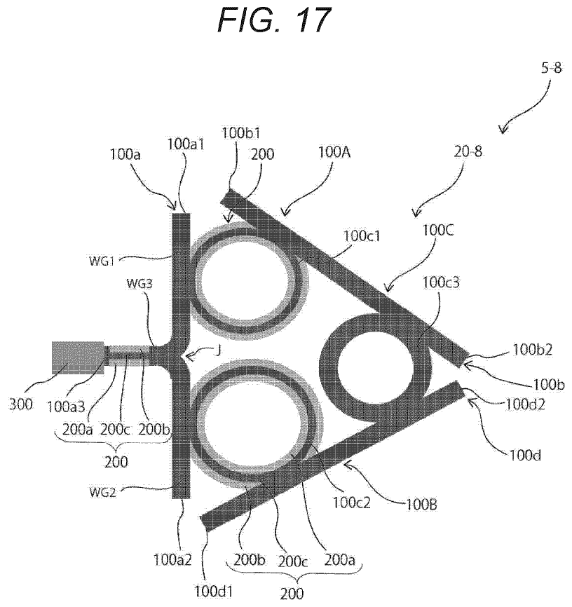

Hereinafter, a light source device according to Example 8 of the second embodiment of the present technology will be described. FIG. 17 is a diagram schematically illustrating a planar configuration of a light source device 5-8 according to Example 8 of the second embodiment of the present technology.

The light source device 5-8 has a configuration similar to the light source device 5-7 according to Example 7 except that the phase shifter 200 is not provided in a third ring resonator 100c3 of an optical modulator 20-8.

<18. Light Source Device according to Example 9 of Second Embodiment of Present Technology>

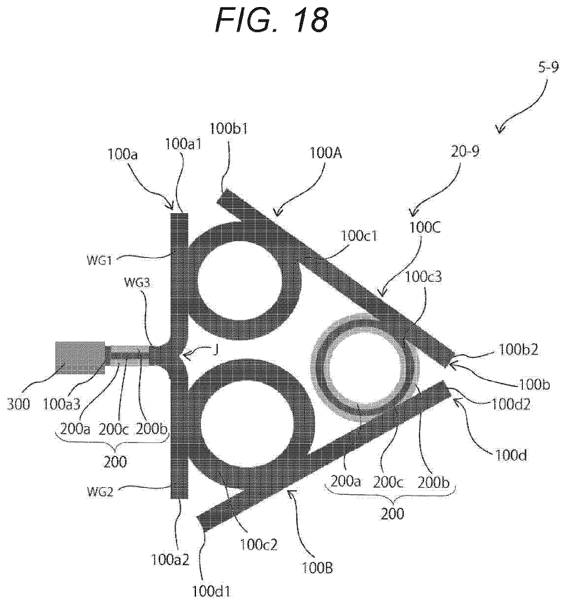

Hereinafter, a light source device according to Example 9 of the second embodiment of the present technology will be described. FIG. 18 is a diagram schematically illustrating a planar configuration of a light source device 5-9 according to Example 9 of the second embodiment of the present technology.

The light source device 5-9 has a configuration similar to the light source device 5-7 according to Example 7 except that the phase shifter 200 is not provided in first and second ring resonators 100c1 and 100c2 of an optical modulator 20-9.

<19. Light Source Device according to Example 10 of Second Embodiment of Present Technology>

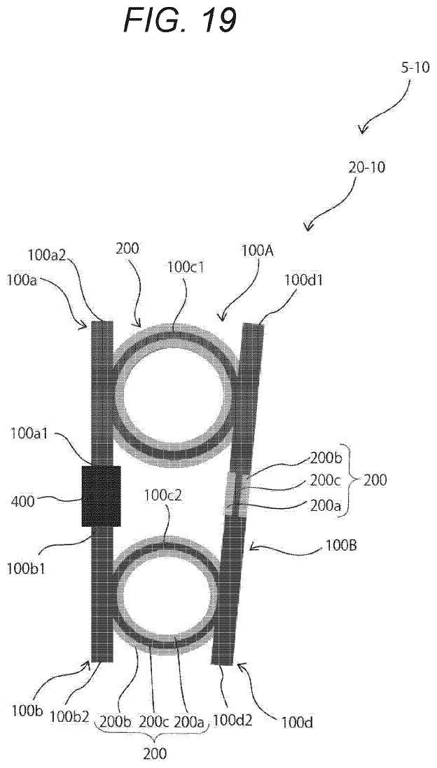

Hereinafter, a light source device according to Example 10 of the second embodiment of the present technology will be described. FIG. 19 is a diagram schematically illustrating a planar configuration of a light source device 5-10 according to Example 10 of the second embodiment of the present technology.

The light source device 5-10 includes an optical amplifier 400 and an optical modulator 20-10 into which light from the optical amplifier 400 is incident.

As the optical amplifier 400, for example, a transmissive semiconductor optical amplifier (SOA), an end surface emitting laser, or the like can be used.

The optical modulator 20-10 includes first to third optical waveguides 100a, 100b, and 100d and first and second ring resonators 100c1 and 100c2. All of the first to third optical waveguides 100a, 100b, and 100d are linear waveguides (for example, Si fine wire waveguides). Here, the at least one linear waveguide and/or the at least one ring waveguide is a photonic crystal waveguide PCW having a photonic crystal structure PCS (see FIGS. 36 to 38).

One end 100a1 of the first optical waveguide 100a is connected to an output port of the optical amplifier 400. One end 100b1 of the second optical waveguide 100b is connected to another output port of the optical amplifier 400. A phase shifter 200 is provided in the third optical waveguide 100d.

The first ring resonator 100c1 is optically coupled to the first and third optical waveguides 100a and 100d. Here, the first and third optical waveguides 100a and 100d sandwich the first ring resonator 100c1 in the in-plane direction. A first resonator device 100A includes the first and third optical waveguides 100a and 100d and the first ring resonator 100c1. Note that at least one of the first and third optical waveguides 100a and 100d and the first ring resonator 100c1 may be separated from each other so as to be optically couplable.

The second ring resonator 100c2 is optically coupled to the second and third optical waveguides 100b and 100d. Here, the second and third optical waveguides 100b and 100d sandwich the second ring resonator 100c2 in the in-plane direction. A second resonator device 100B includes the second and third optical waveguides 100b and 100d and the second ring resonator 100c2. Note that at least one of the second and third optical waveguides 100b and 100d and the second ring resonator 100c2 may be separated from each other so as to be optically couplable.

The first and second ring resonators 100c1 and 100c2 may have the same resonance wavelength or different resonance wavelengths. A phase shifter 200 is provided in each of the first and second ring resonators 100c1 and 100c2.

In the light source device 5-10, the light output from the optical amplifier 400 to each of the first and second optical waveguides 100a and 100b can be wavelength-modulated and output from at least one of the other end 100a2 of the first optical waveguide 100a, the other end 100b2 of the second optical waveguide 100b, the one end 100d1 of the third optical waveguide 100d, and the other end 100d2 thereof via at least one of the first and second ring resonators 100c1 and 100c2. At this time, it is preferable to synchronously control the phase shifter 200 provided in each of the first and second ring resonators 100c1 and 100c2 and the phase shifter 200 provided in the third optical waveguide 100d. Thereby, continuous wavelength modulation without a mode hop can be performed.

In the light source device 5-10, the spectral linewidth reduction effect can be obtained by the vernier effect by the first and second ring resonators 100c1 and 100c2.

<20. Light Source Device according to Example 11 of Second Embodiment of Present Technology>

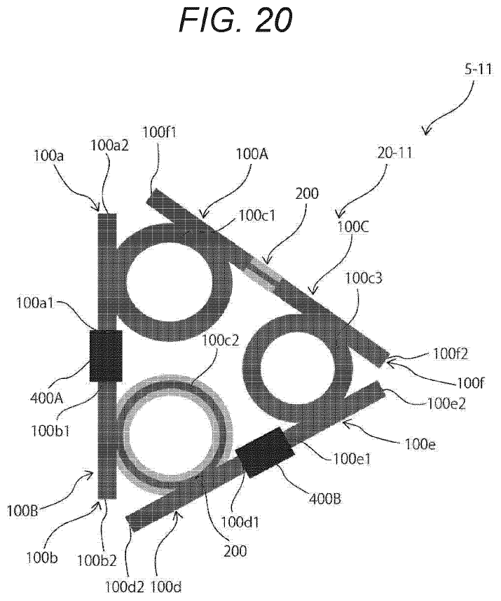

Hereinafter, a light source device according to Example 11 of the second embodiment of the present technology will be described. FIG. 20 is a diagram schematically illustrating a planar configuration of a light source device 5-11 according to Example 11 of the second embodiment of the present technology.

The light source device 5-11 includes first and second optical amplifiers 400A and 400B, and an optical modulator 20-11 to which light from each of the first and second optical amplifiers 400A and 400B is incident.

As each of the first and second optical amplifiers 400A and 400B, for example, a transmissive semiconductor optical amplifier (SOA), an end surface emitting laser, or the like can be used.

The optical modulator 20-11 includes first to fifth optical waveguides 100a, 100b, 100d, 100e, and 100f and first to second ring resonators 100c1, 100c2, and 100c. All of the first to fifth optical waveguides 100a, 100b, 100d, 100e, and 100f are linear waveguides (for example, Si fine wire waveguides). Here, the at least one linear waveguide and/or the at least one ring waveguide is a photonic crystal waveguide PCW having a photonic crystal structure PCS (see FIGS. 36 to 38).

One end 100a1 of the first optical waveguide 100a is connected to an output port of the first optical amplifier 400A. One end 100b1 of the second optical waveguide 100b is connected to another output port of the first optical amplifier 400A. One end 100d1 of the third optical waveguide 100d is connected to an output port of the second optical amplifier 400B. One end 100e1 of the fourth optical waveguide 100e is connected to another output port of the second optical amplifier 400B. A phase shifter 200 is provided in the fifth optical waveguide 100f.

The first ring resonator 100c1 is optically coupled to the first and fifth optical waveguides 100a and 100f. Here, for example, the first and fifth optical waveguides 100a and 100f arranged to form an acute angle sandwich the first ring resonator 100c1 in the in-plane direction. A first resonator device 100A includes the first and fifth optical waveguides 100a and 100f and the first ring resonator 100c1. Note that at least one of the first and fifth optical waveguides 100a and 100f and the first ring resonator 100c1 may be separated from each other so as to be optically couplable.

The second ring resonator 100c2 is optically coupled to the second and third optical waveguides 100b and 100d. Here, for example, the second and third optical waveguides 100b and 100d arranged to form an acute angle sandwich the second ring resonator 100c2 in the in-plane direction. A second resonator device 100B includes the second and third optical waveguides 100b and 100d and the second ring resonator 100c2. Note that at least one of the second and third optical waveguides 100b and 100d and the second ring resonator 100c2 may be separated from each other so as to be optically couplable.

The third ring resonator 100c3 is optically coupled to the fourth and fifth optical waveguides 100e and 100f. Here, for example, the fourth and fifth optical waveguides 100e and 100f arranged to form an acute angle sandwich the third ring resonator 100c3 in the in-plane direction. A third resonator device 100C includes the fourth and fifth optical waveguides 100e and 100f and the third ring resonator 100c3. Note that at least one of the fourth and fifth optical waveguides 100e and 100f and the third ring resonator 100c3 may be separated from each other so as to be optically couplable.

At least two of the first to third ring resonators 100c1, 100c2, and 100c3 may have the same resonance wavelength or different resonance wavelengths. A phase shifter 200 is provided in the second ring resonator 100c2.

In the light source device 5-10, the light output from the first optical amplifier 400A to each of the first and second optical waveguides 100a and 100b and the light output from the second optical amplifier 400B to each of the third and fourth optical waveguides 100d and 100e can be wavelength-modulated and output from at least one of the other end 100a2 of the first optical waveguide 100a, the other end 100b2 of the second optical waveguide 100b, the other end 100d2 of the third optical waveguide 100d, the other end 100e2 of the fourth optical waveguide 100e, one end 100f1 of the fifth optical waveguide 100f, and the other end 100f2 thereof via at least one of the first to third ring resonators 100c1, 100c2, and 100c3. At this time, it is preferable to synchronously control the phase shifter 200 provided in the second ring resonator 100c2 and the phase shifter 200 provided in the fifth optical waveguide 100f. Thereby, continuous wavelength modulation without a mode hop can be performed.

In the light source device 5-11, the spectral linewidth reduction effect can be obtained by the vernier effect by the first to third ring resonators 100c1, 100c2, and 100c3.

<21. Light Source Device according to Example 12 of Second Embodiment of Present Technology>

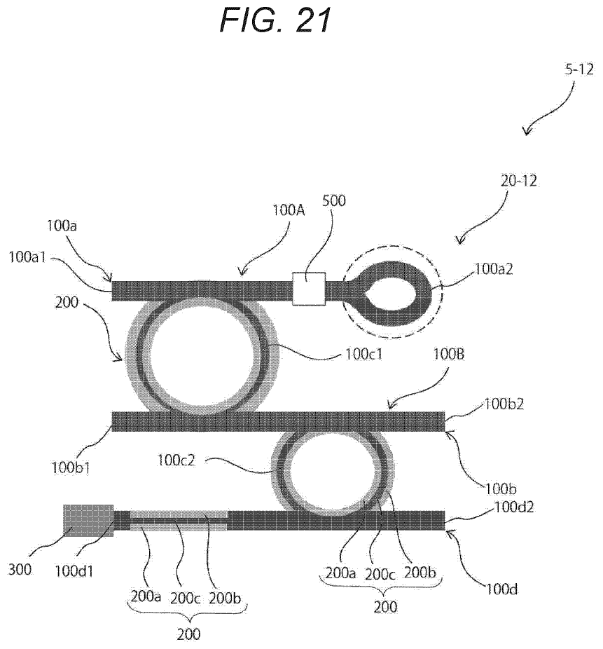

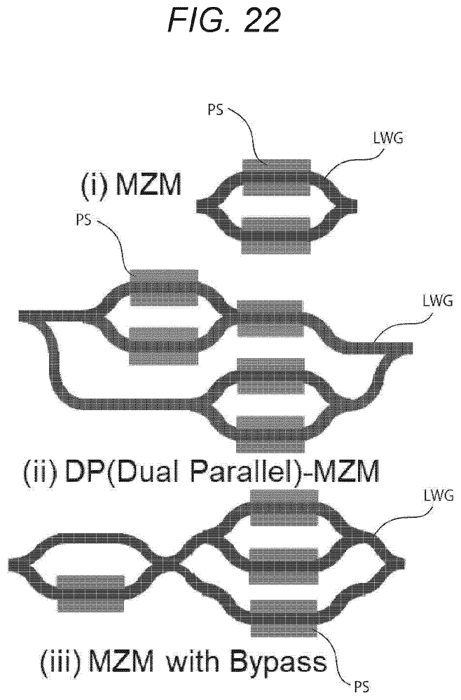

Hereinafter, a light source device according to Example 12 of the second embodiment of the present technology will be described. FIG. 21 is a diagram schematically illustrating a planar configuration of a light source device 5-12 according to Example 12 of the second embodiment of the present technology. FIG. 22 is a diagram illustrating a configuration example of a Mach-Zehnder modulator.

The light source device 5-12 has a configuration similar to the light source device 5-1 (see FIG. 10) according to Example 1 except that a Mach-Zehnder modulator 500 (MZM) is provided in a first optical waveguide 100a of an optical modulator 20-12.

Here, the Mach-Zehnder modulator 500 is provided in the first optical waveguide 100a at a position between the optical coupling portion between the first ring resonator 100cl and the first optical waveguide 100a and the Sagnac loop.

By applying a predetermined RF signal to the phase shifter included in the Mach-Zehnder modulator 500, continuous wavelength modulation without a mode hop can be performed at a higher speed and stably.

Note that the Mach-Zehnder modulator 500 may be provided in at least one of the second and third optical waveguides 100b and 100d instead of or in addition to the first optical waveguide 100a.

Configuration examples of the of the Mach-Zehnder modulator 500 include the configurations (i) to (iii) illustrated in FIG. 22.

(i) A configuration in which incident light is branched into two optical waveguides LWG provided with a phase shifter PS (pn junction), and is merged after giving a phase difference (to supplement, by applying a bias voltage to the pn junction as the phase shifter PS provided in each optical waveguide LWG, the refractive index of the optical waveguide LWG is changed to change the phase of light).

(ii) A configuration obtained by connecting, in parallel, a configuration in which the optical waveguide LWG provided with the phase shifter PS and the configuration of (i) are connected in series and the configuration of (i)

(iii) A configuration obtained by directly connecting a configuration in which the optical waveguide LWG provided with the phase shifter PS and the configuration of (i) are connected in parallel and a configuration in which the phase shifter PS is provided only in one optical waveguide LWG in the configuration of (i).

<22. Light Source Device according to Example 13 of Second Embodiment of Present Technology>

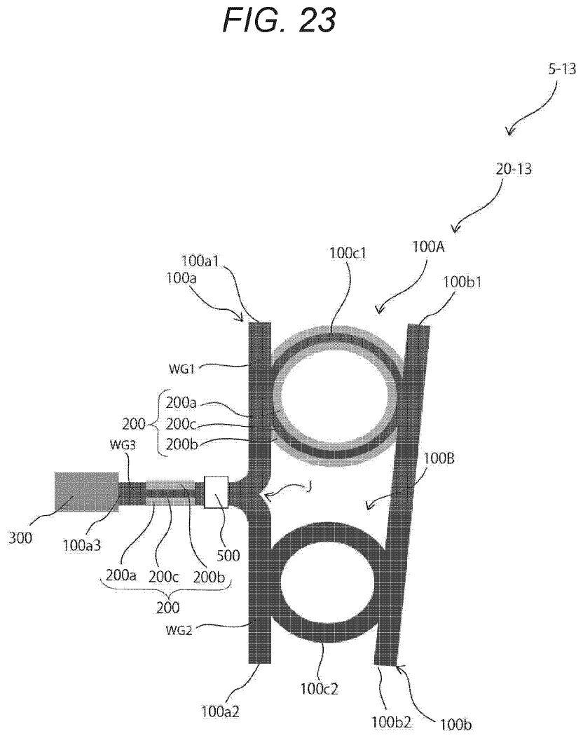

Hereinafter, a light source device according to Example 13 of the second embodiment of the present technology will be described. FIG. 23 is a diagram schematically illustrating a planar configuration of a light source device 5-13 according to Example 13 of the second embodiment of the present technology.

The light source device 5-13 has a configuration similar to the light source device 5-5 (see FIG. 14) according to Example 5 except that a Mach-Zehnder modulator 500 (MZM) is provided in a waveguide portion WG3 of an optical modulator 20-13.

In the light source device 5-13, by applying a predetermined RF signal to the phase shifter included in the Mach-Zehnder modulator 500, continuous wavelength modulation without a mode hop can be performed at a higher speed and stably.

Note that the Mach-Zehnder modulator 500 may be provided in at least one of the waveguide portions WG1 and WG2 instead of or in addition to the waveguide portion WG3.

<23. Light Source Device according to Example 14 of Second Embodiment of Present Technology>

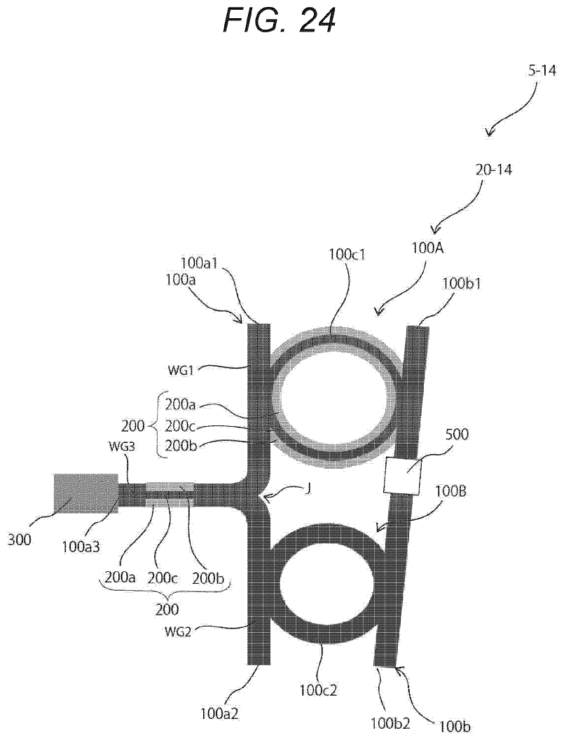

Hereinafter, a light source device according to Example 14 of the second embodiment of the present technology will be described. FIG. 24 is a diagram schematically illustrating a planar configuration of a light source device 5-14 according to Example 14 of the second embodiment of the present technology.

The light source device 5-14 has a configuration similar to the light source device 5-5 (see FIG. 14) according to Example 5 except that a Mach-Zehnder modulator 500 (MZM) is provided in a second optical waveguide 100b of an optical modulator 20-14.

Here, the Mach-Zehnder modulator 500 is provided in the second optical waveguide 100b at a position between an optical coupling portion between the first ring resonator 100cl and the second optical waveguide 100b and an optical coupling portion between the second ring resonator 100c2 and the second optical waveguide 100b.

In the light source device 5-14, by applying a predetermined RF signal to the phase shifter included in the Mach-Zehnder modulator 500, continuous wavelength modulation without a mode hop can be performed at a higher speed and stably.

<24. Light Source Device according to Example 15 of Second Embodiment of Present Technology>

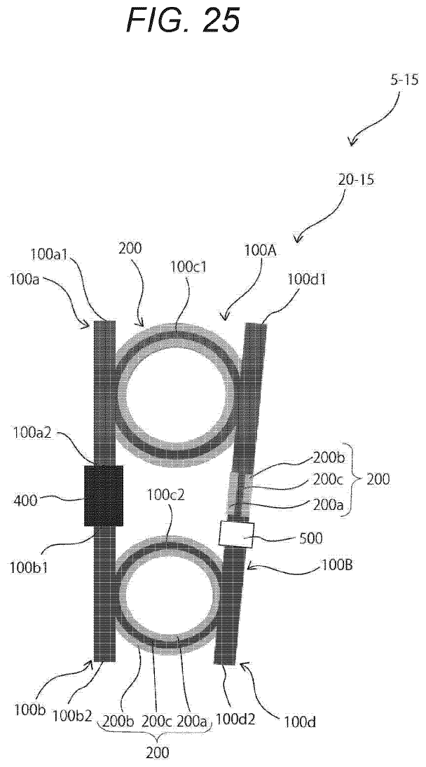

Hereinafter, a light source device according to Example 15 of the second embodiment of the present technology will be described. FIG. 25 is a diagram schematically illustrating a planar configuration of a light source device 5-15 according to Example 15 of the second embodiment of the present technology.

The light source device 5-15 has a configuration similar to the light source device 5-10 (see FIG. 19) according to Example 10 except that a Mach-Zehnder modulator 500 (MZM) is provided in a third optical waveguide 100d of an optical modulator 20-15.

Here, the Mach-Zehnder modulator 500 is provided in the third optical waveguide 100d at a position between an optical coupling portion between the first ring resonator 100c1 and the third optical waveguide 100d and an optical coupling portion between the second ring resonator 100c2 and the third optical waveguide 100d.

In the light source device 5-15, by applying a predetermined RF signal to the phase shifter included in the Mach-Zehnder modulator 500, continuous wavelength modulation without a mode hop can be performed at a higher speed and stably.

Note that the Mach-Zehnder modulator 500 may be provided in at least one of the first and second optical waveguides 100a and 100b instead of or in addition to the third optical waveguide 100d.

<25. Light Source Device according to Example 16 of Second Embodiment of Present Technology>

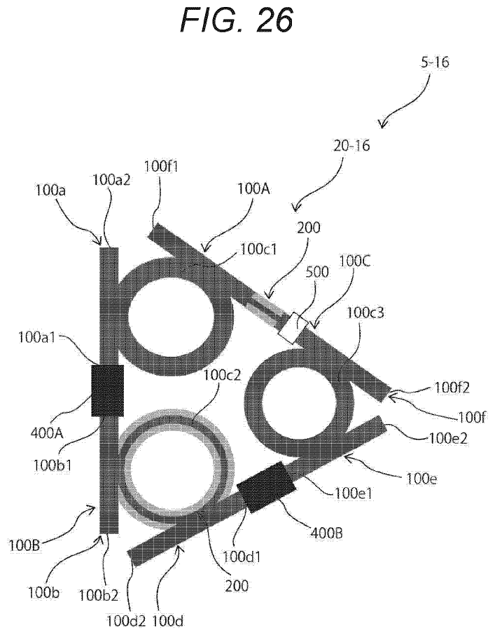

Hereinafter, a light source device according to Example 16 of the second embodiment of the present technology will be described. FIG. 26 is a diagram schematically illustrating a planar configuration of a light source device 5-16 according to Example 16 of the second embodiment of the present technology.

The light source device 5-16 has a configuration similar to the light source device 5-11 (see FIG. 20) according to Example 11 except that a Mach-Zehnder modulator 500 (MZM) is provided in a fifth optical waveguide 100b of an optical modulator 20-16.

Here, the Mach-Zehnder modulator 500 is provided in the fifth optical waveguide 100f at a position between an optical coupling portion between the first ring resonator 100c1 and the fifth optical waveguide 100f and an optical coupling portion between the third ring resonator 100c3 and the fifth optical waveguide 100f.

In the light source device 5-16, by applying a predetermined RF signal to the phase shifter included in the Mach-Zehnder modulator 500, continuous wavelength modulation without a mode hop can be performed at a higher speed and stably.

Note that the Mach-Zehnder modulator 500 may be provided in at least one of the first to fourth optical waveguides 100a, 100b, 100d, and 100e instead of or in addition to the fifth optical waveguide 100f.

<26. Light Source Device according to Example 17 of Second Embodiment of Present Technology>

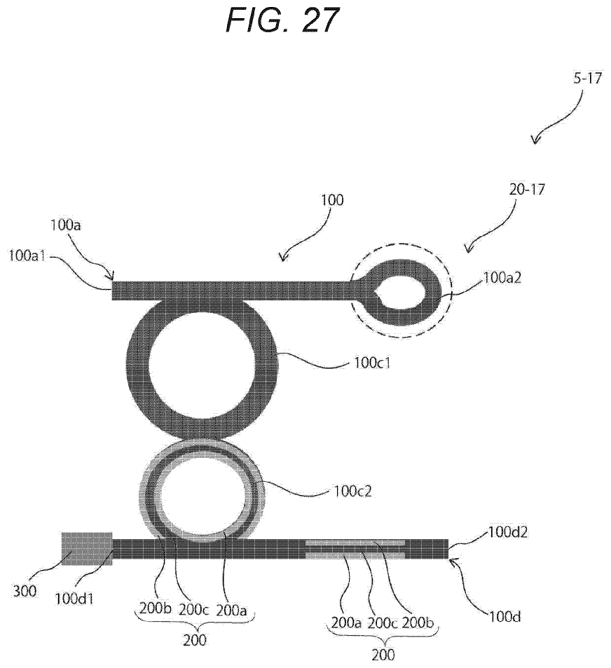

Hereinafter, a light source device according to Example 17 of the second embodiment of the present technology will be described. FIG. 27 is a diagram schematically illustrating a planar configuration of a light source device 5-17 according to Example 17 of the second embodiment of the present technology.

The light source device 5-17 has a configuration similar to the light source device 5-2 (see FIG. 11) according to Example 2 except that an optical modulator 20-17 does not have the second optical waveguide 100 b, and the first and second ring resonators 100c1 and 100c2 constitute a double ring resonator (composite resonator).

In the optical modulator 20-17, the first and second ring resonators 100c1 and 100c2 are connected directly or in parallel. In the optical modulator 20-17, a resonator device 100 includes a double ring resonator (first and second ring resonators 100c1 and 100c2) and first and third optical waveguides 100a and 100d.

Note that three or more ring resonators may be connected in series or in parallel to form a composite resonator.

<27. Distance Measuring Device according to Third Embodiment of Present Technology>

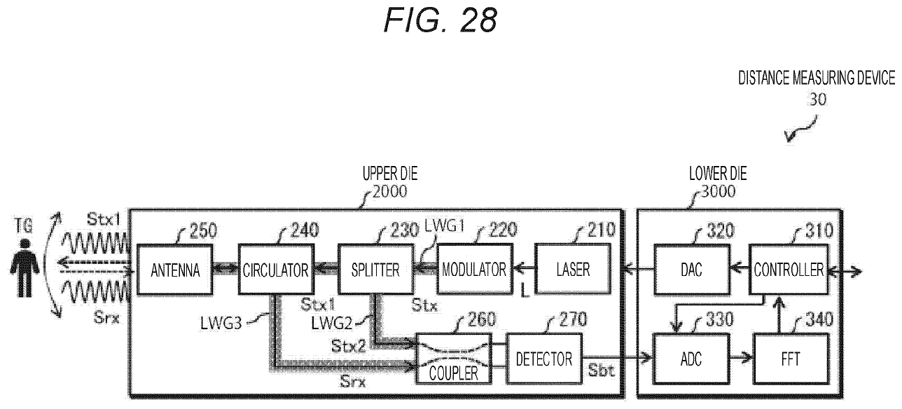

Hereinafter, a distance measuring device according to a third embodiment of the present technology will be described. FIG. 28 is a block diagram illustrating a configuration example of a distance measuring device 30 according to a third embodiment of the present technology.

The distance measuring device 30 is a frequency modulated continuous wave (FMCW) LiDAR. In the FMCW LiDAR, laser light (transmission signal) modulated so that the frequency linearly increases with the lapse of time is continuously emitted, and the distance is obtained from the frequency difference between the transmission signal and the reflected light (return signal).

For example, as illustrated in FIG. 28, the distance measuring device 30 includes an upper die 2000 and a lower die 3000. The upper die 2000 and the lower die 3000 are actually stacked on each other and electrically connected to each other.

### (Upper Die 2000)

The upper die 2000 includes a laser 210, a modulator 220 (optical modulator), a splitter 230, a circulator 240, an antenna 250, a coupler 260, and a detector 270. In the upper die 2000, the modulator 220, the splitter 230, the circulator 240, the antenna 250, the coupler 260, and the detector 270 are formed in a photonic integration circuit (PIC) substrate.

The laser 210 is a light source chip that generates an optical signal. The laser 210 is, for example, a chip-shaped end surface emitting semiconductor laser (end surface emitting laser), and emits laser light L having a predetermined fixed wavelength (for example, 1550 nm) from an end surface of an active layer under the control of a controller 310.

The laser light L emitted from the laser 210 enters an optical waveguide LWG1. The laser light L propagating through the optical waveguide LWG1 is input to the modulator 220.

As the modulator 220, for example, the optical modulators 10-1 to 10-9 according to Examples 1 to 9 of the first embodiment and the optical modulators 20-1 to 20-17 of the light source devices 5-1 to 5-17 according to Examples 1 to 17 of the second embodiment can be used.

The modulator 220 frequency-modulates the laser light L under the control of the controller 310. For example, the modulator 220 modulates the laser light L such that the frequency increases linearly with the lapse of time, and then modulates the laser light L such that the frequency decreases linearly with the lapse of time. For example, the modulator 220 periodically repeats such linear rising and falling of the frequency, and outputs a transmission signal Stx generated thereby to the splitter 230 via the optical waveguide LWG1. The transmission signal Stx is a chirp signal obtained by frequency-modulating the laser light L by the modulator 220.

The splitter 230 divides the transmission signal Stx into a transmission signal Stx (transmission signal Stx1) for irradiating a target TG and a transmission signal Stx (transmission signal Stx2) for causing the coupler 260 to interfere with a return signal Srx. The transmission signal Stx1 has most of the energy of the transmission signal Stx. The transmit signal Stx2 is a reference signal having an amount of energy much smaller than energy of the transmit signal Stx1, but sufficient to cause the coupler 260 to interfere with the return signal Srx. The return signal Srx corresponds to a signal whose phase is delayed in relation to the transmission signal Stx1. The return signal Srx is generated by the transmission signal Stx being reflected by the target TG.

The splitter 230 is an element having 3 ports. In the splitter 230, the first port and the third port exist in the optical waveguide LWG1. The second port exists in the optical waveguide LWG2. The optical waveguide LWG2 is arranged close to a portion of the optical waveguide LWG1 between the first port and the third port. As a result, the optical signal propagating through the optical waveguide LWG1 leaks to the optical waveguide LWG2. The optical signal leaking from the optical waveguide LWG1 to the optical waveguide LWG2 propagates through the optical waveguide LWG2 as the transmission signal Stx2.

The circulator 240 is an element having 3 ports, and transmits the transmission signal Stx1 incident from the first port to the third port and transmits the return signal Srx incident from the third port to the second port. In the circulator 240, the optical waveguide LWG1 is coupled to the first port, and the optical waveguide LWG2 is coupled to the second port. An optical waveguide extending from the antenna 250 is coupled to the third port. The circulator 240 functions to rectify, for example, an optical signal to be transmitted and an optical signal received from the antenna 250. In the circulator 240, the signal strength of the transmission signal and the reception signal is divided by 50% and 50% in each branch due to a structure in which an optical waveguide including Si branches. By handling this half signal, transmission light and reception light can be separated.

The antenna 250 is a mechanical less scanner having no drive unit. The antenna 250 transmits the transmission signal Stx1 toward the target TG via the lens, and receives the return signal Srx via the lens.

The coupler 260 is an element that generates a beat signal Sbt by interference between the transmission signal Stx2 and the return signal Srx. The frequency of the beat signal Sbt changes according to the frequency difference between the transmission signal Stx2 and the return signal Srx. The frequency difference changes according to the distance from the antenna 250 to the target TG. Therefore, the distance from the antenna 250 to the target TG can be estimated on the basis of the frequency of the beat signal Sbt.

The detector 270 is an element that extracts the beat signal Sbt from the signal propagated from the coupler 260. The detector 270 includes two GePDs connected in series to each other and a transimpedance amplifier connected to a connection node of the two GePDs.

The transimpedance amplifier performs impedance conversion and amplification on the current signal photoelectrically converted by each GePD, and outputs a beat signal Sbt as a voltage signal.

### (Lower Die 3000)

For example, as illustrated in FIG. 28, the lower die 3000 includes a controller 310, a DAC 320, an ADC 330, and a fast Fourier transform (FFT) 340.

For example, the controller 310 generates a control signal for controlling the laser 210, the modulator 220, the antenna 250, and the detector 270, and outputs the control signal to the DAC 320. The controller 310 further generates a control signal for controlling the ADC 330, for example, and outputs the control signal to the ADC 330. The DAC 320 DA-converts the control signal input from the controller 310, and outputs an analog control signal to the laser 210, the modulator 220, the antenna 250, and the detector 270. The ADC 330 performs AD conversion on the beat signal Sbt input from the detector 270 and outputs the converted signal to the FFT 340. The FFT 340 performs FFT on the digital beat signal Sbt input from the ADC 330 and derives the frequency of the beat signal Sbt on the basis of the power spectrum density obtained by the FFT. The FFT 340 outputs information (frequency information) about the derived frequency to the controller 310. The controller 310 outputs the frequency information input from the FFT 340 to the outside according to control from the outside.

The lower die 3000 has a Si substrate. On the Si substrate, for example, signal processing circuits such as the controller 310, the DAC 320, the ADC 330, and the FFT 340 are formed.

Note that, in the distance measuring device 30, instead of the light source device including the laser 210 and the modulator 220, the light source device according to each example of the second embodiment may be used.

Meanwhile, a resonator device including an optical waveguide and a ring resonator and a ring resonator can be applied to, for example, an optical filter incorporated in an optical network since the ring resonator has a function as a filter that passes only light of a specific wavelength. In addition, a resonator device having an optical waveguide and a ring resonator and a ring resonator can be expected to be applied to an external resonator of a laser, a biosensor, an optical switch, and the like.

<28. Resonator Device according to Example 1 of Fourth Embodiment of Present Technology>

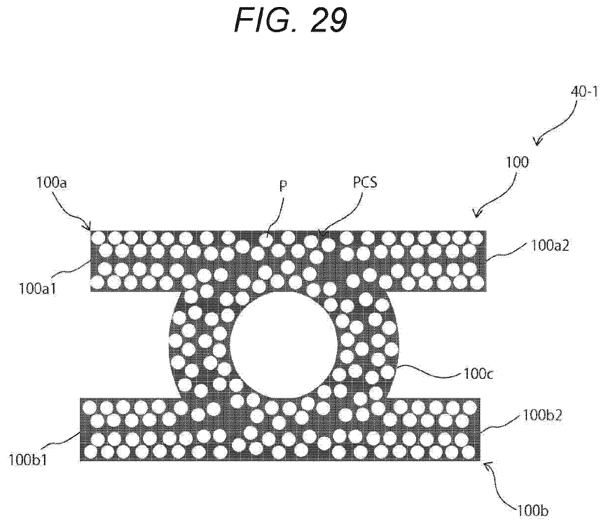

Hereinafter, a resonator device according to Example 1 of a fourth embodiment of the present technology will be described. FIG. 29 is a diagram schematically illustrating a planar configuration of a resonator device 40-1 according to Example 1 of the fourth embodiment of the present technology.

The resonator device 40-1 has a configuration in which the phase shifter 200 is removed from the ring resonator 100c of the optical modulator 10-1 (see FIG. 1) according to Example 1 of the first embodiment. Since each linear waveguide and the ring waveguide are photonic crystal waveguides PCW (see FIG. 37), the resonator device 40-1 can realize a highly efficient (low loss) 2 to 4 port resonator device.

<29. Resonator Device according to Example 2 of Fourth Embodiment of Present Technology>

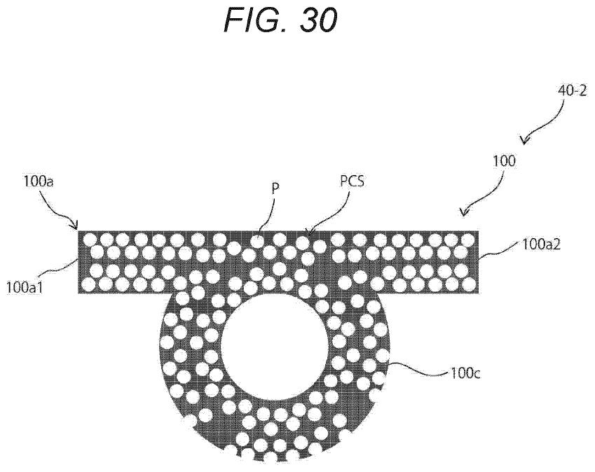

Hereinafter, a resonator device according to Example 2 of the fourth embodiment of the present technology will be described. FIG. 30 is a diagram schematically illustrating a planar configuration of a resonator device 40-2 according to Example 2 of the fourth embodiment of the present technology.

The resonator device 40-2 has a configuration similar to the resonator device 40-1 according to Example 1 except that the second optical waveguide 100b is not included. Since the linear waveguide and the ring waveguide are photonic crystal waveguides PCW (see FIG. 37), the resonator device 40-2 can realize a two-port resonator device with high efficiency (low loss).

<30. Resonator Device according to Example 3 of Fourth Embodiment of Present Technology>

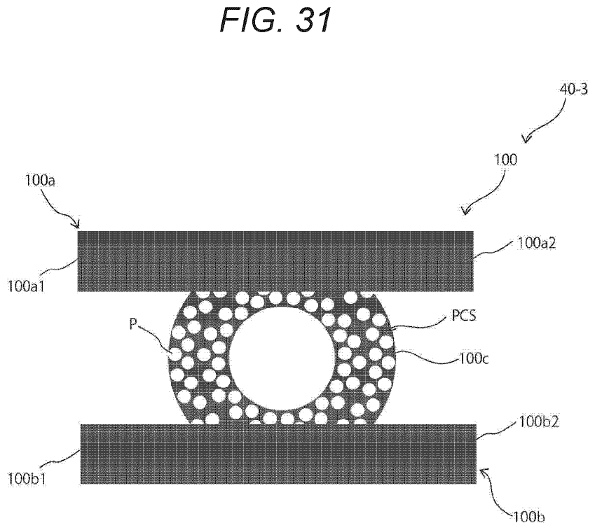

Hereinafter, a resonator device according to Example 3 of the fourth embodiment of the present technology will be described. FIG. 31 is a diagram schematically illustrating a planar configuration of a resonator device 40-3 according to Example 3 of the fourth embodiment of the present technology.

The resonator device 40-3 has a configuration similar to the resonator device 40-1 according to Example 1 except that both of the first and second optical waveguides 100a and 100b are linear waveguides that are not photonic crystal waveguides. In the resonator device 40-3, since the ring waveguide is a photonic crystal waveguide PCW (see FIG. 37), a highly efficient (low loss) 2 to 4 port resonator device can be realized.

<31. Resonator Device according to Example 4 of Fourth Embodiment of Present Technology>

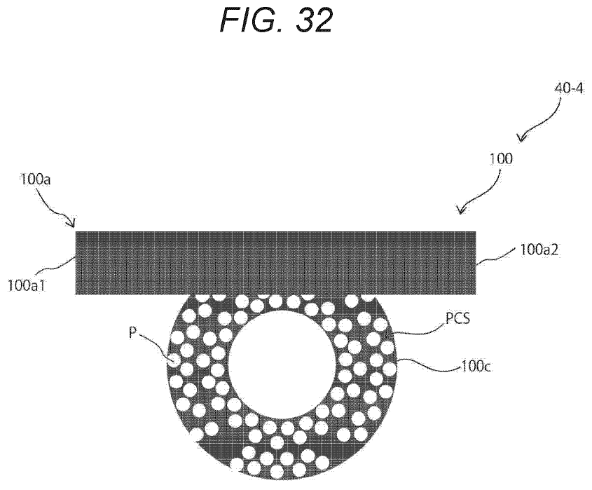

Hereinafter, a resonator device according to Example 4 of the fourth embodiment of the present technology will be described. FIG. 32 is a diagram schematically illustrating a planar configuration of a resonator device 40-4 according to Example 4 of the fourth embodiment of the present technology.

The resonator device 40-4 has a configuration similar to the resonator device 40-2 according to Example 2 except that the first optical waveguide 100 a is a linear waveguide that is not a photonic crystal waveguide. In the resonator device 40-2, since the ring waveguide is a photonic crystal waveguide PCW (see FIG. 37), a highly efficient (low loss) 2 port resonator device can be realized.

<32. Resonator Device according to Example 5 of Fourth Embodiment of Present Technology>

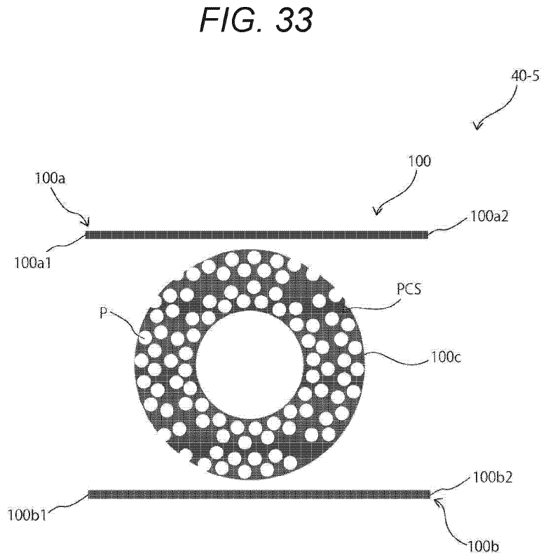

Hereinafter, a resonator device according to Example 5 of the fourth embodiment of the present technology will be described. FIG. 33 is a diagram schematically illustrating a planar configuration of a resonator device 40-5 according to Example 5 of the fourth embodiment of the present technology.

The resonator device 40-5 has a configuration in which the phase shifter 200 is removed from the ring resonator 100 c of the optical modulator 10-6 (see FIG. 6) according to Example 6 of the first embodiment. In the resonator device 40-5, since the ring waveguide is a photonic crystal waveguide PCW (see FIG. 37), a highly efficient (low loss) 2 to 4 port resonator device can be realized.

<33. Resonator Device according to Example 6 of Fourth Embodiment of Present Technology>

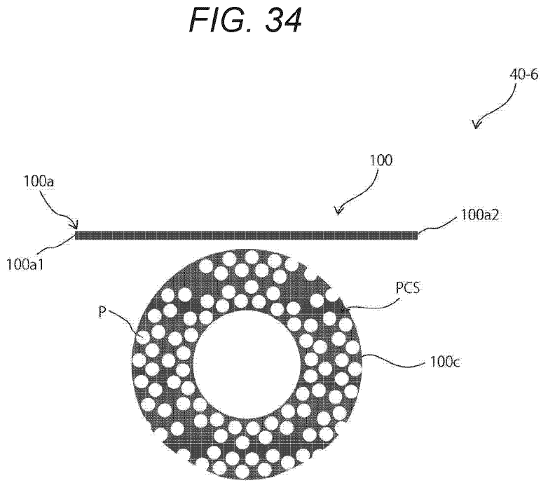

Hereinafter, a resonator device according to Example 6 of the fourth embodiment of the present technology will be described. FIG. 34 is a diagram schematically illustrating a planar configuration of a resonator device 40-6 according to Example 6 of the fourth embodiment of the present technology.

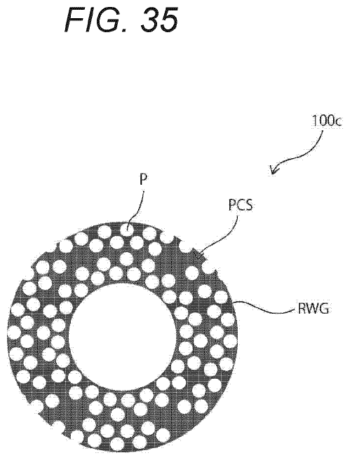

The resonator device 40-6 has a configuration similar to the resonator device 40-5 according to Example 5 except that the second optical waveguide 100b is not included. In the resonator device 40-6, since the ring waveguide is a photonic crystal waveguide PCW (see FIG. 37), a highly efficient (low loss) 2 port resonator device can be realized.

<34. Ring resonator according to fifth embodiment of present technology>Hereinafter, a ring resonator according to a fifth embodiment of the present technology will be described. FIG. 35 is a diagram schematically illustrating a planar configuration of a ring resonator 100c according to the fifth embodiment of the present technology.

The ring resonator 100c according to the fifth embodiment has a configuration in which the first optical waveguide 100a is removed from the resonator device 40-6 according to Example 6 of the fourth embodiment. The ring resonator 100c can realize a high-efficiency (low-loss) ring resonator because the ring waveguide RWG (ring-shaped optical waveguide) is a photonic crystal waveguide PCW (see FIG. 37) having a photonic crystal structure PCS.

### <35. Modification of the Present Technology>

The present technology is not limited to the embodiments described above, and various modifications can be made.

For example, the optical modulator according to each example of the first embodiment may be provided inside or outside the resonator of the Fabry-Perot laser. As a result, automatic matching to the laser frequency occurs, so that modulation with high speed and low power consumption can be performed.

For example, in the light source device according to each example of the second embodiment, the phase shifter 200 may be provided only in the linear waveguide.

For example, each of the resonator device, the optical modulator, the light source device, and the distance measuring device according to the present technology may include four or more ring resonators.

For example, each of the light source device and the distance measuring device according to the present technology may include three or more optical amplifiers.

At least two configurations among the configuration of the optical modulator according to each example of the first embodiment, the configuration of the light source device according to each example of the second embodiment, and the configuration of the resonator device according to each example of the fourth embodiment may be combined within a range not contradictory to each other.

The material, conductivity type, thickness, width, length, shape, size, arrangement, and the like of each component constituting the ring resonator, the optical modulator, the resonator device, the light source device, and the distance measuring device can be appropriately changed within a range of functioning as the ring resonator, the optical modulator, the resonator device, the light source device, and the distance measuring device.

Furthermore, the present technology may also adopt the following configurations.

(1) A ring resonator including:
a ring-shaped optical waveguide, in which
the optical waveguide has a photonic crystal structure.

(2) An optical modulator including:
an optical waveguide;
a ring resonator optically coupled to the optical waveguide; and
a phase shifter provided in the ring resonator and/or the optical waveguide, in which
at least the ring resonator among the ring resonator and the optical waveguide has a photonic crystal structure.

(3) The optical modulator according to (2), in which the ring resonator and the optical waveguide have a photonic crystal structure.

(4) The optical modulator according to (2) or (3), in which only the ring resonator of the ring resonator and the optical waveguide has a photonic crystal structure.

(5) The optical modulator according to (2) or (3), in which the phase shifter is provided in the ring resonator.

(6) The optical modulator according to any one of (2) to (4), further including a plurality of the ring resonators.

(7) The optical modulator according to (6), in which the phase shifter is provided in at least one ring resonator of the plurality of ring resonators.

(8) The optical modulator according to (6) or (7), in which the phase shifter is provided in some ring resonators among the plurality of ring resonators, and the phase shifter is not provided in the other ring resonators.

(9) The optical modulator according to any one of (6) to (8), in which the phase shifter is not provided in at least one ring resonator of the plurality of ring resonators.

(10) The optical modulator according to any one of (2) to (9), including a plurality of the optical waveguides.

(11) The optical modulation device according to any one of (2) to (10), further including a plurality of the ring resonators and a plurality of the optical waveguides, in which each of the plurality of ring resonators is optically coupled to at least two optical waveguides of the plurality of optical waveguides.

(12) The optical modulator according to any one of (2) to (11), in which the optical waveguide includes a branch portion or a combining portion.

(13) The optical modulator according to any one of (2) to (12), in which an end of the optical waveguide is connected to an optical amplifier.

(14) The optical modulator according to (13), in which the phase shifter is provided at a position of the optical waveguide between an optical coupling portion between the optical waveguide and the ring resonator and the optical amplifier.

(15) The optical modulator according to any one of (2) to (14), in which a mirror is provided at an end of the optical waveguide.

(16) The optical modulator according to (15), in which the mirror is a Sagnac loop or a distributed Bragg reflector.

(17) The optical modulator according to any one of (2) to (16), in which a Mach-Zehnder modulator is provided in the optical waveguide.

(18) The optical modulator according to any one of (2) to (17), in which in the photonic crystal structure, a pore of a photonic crystal includes an air gap or a material having a refractive index different from a refractive index of a waveguide portion.

(19) A light source device including:
an optical amplifier; and
an optical modulator to which light from the optical amplifier is incident, in which the optical modulator includes:
an optical waveguide;
a ring resonator optically coupled to the optical waveguide; and
a phase shifter provided in the ring resonator and/or the optical waveguide, and at least the ring resonator among the ring resonator and the optical waveguide has a photonic crystal structure.

(20) A distance measuring device including:
an optical amplifier;
an optical modulator to which light from the optical amplifier is incident; and
a light receiving unit that receives light reflected by an object via the optical modulator, in which
the optical modulator includes:
an optical waveguide;
a ring resonator optically coupled to the optical waveguide; and
a phase shifter provided in the ring resonator and/or the optical waveguide, and
at least the ring resonator among the ring resonator and the optical waveguide has a photonic crystal structure.

(21) A resonator device including:
an optical waveguide; and
a ring resonator optically coupled to the optical waveguide, in which
at least the ring resonator among the ring resonator and the optical waveguide has a photonic crystal structure.

### REFERENCE SIGNS LIST

10-1 to 10-9, 20-1 to 20-17 Optical modulator
5-1 to 5-17 Light source device
30 Distance measuring device
40-1 to 40-4 Resonator device
100 Resonator device
100A First resonator device (resonator device)
100B Second resonator device (resonator device)
100C Third resonator device (resonator device)
100a First optical waveguide (optical waveguide)
100b Second optical waveguide (optical waveguide)
100c Ring resonator
100c1 First ring resonator (ring resonator)
100c2 Second ring resonator (ring resonator)
100c3 Third ring resonator (ring resonator)
100d Third optical waveguide (optical waveguide)
100e Fourth optical waveguide (optical waveguide)
100f Fifth optical waveguide (optical waveguide
200 Phase shifter
300 Optical amplifier
400 Optical amplifier
400A First optical amplifier (optical amplifier)
400B Second optical amplifier (optical amplifier)
500 Mach-Zehnder modulator
RWG Ring waveguide (ring-shaped optical waveguide)
PCS Photonic crystal structure
P Pore of photonic crystal

What is claimed is:

1. A ring resonator, comprising:
a ring-shaped optical waveguide, wherein
the optical waveguide has a photonic crystal structure.

2. An optical modulator, comprising:
an optical waveguide;
a ring resonator optically coupled to the optical waveguide; and
a phase shifter provided in the ring resonator and/or the optical waveguide, wherein
at least the ring resonator among the ring resonator and the optical waveguide has a photonic crystal structure.

3. The optical modulator according to claim 2, wherein the ring resonator and the optical waveguide have a photonic crystal structure.

4. The optical modulator according to claim 2, wherein only the ring resonator of the ring resonator and the optical waveguide has a photonic crystal structure.

5. The optical modulator according to claim 2, wherein the phase shifter is provided in the ring resonator.

6 . The optical modulator according to claim 2, further comprising a plurality of the ring resonators.

7. The optical modulator according to claim 6, wherein the phase shifter is provided in at least one ring resonator of the plurality of ring resonators.

8. The optical modulator according to claim 6, wherein the phase shifter is provided in some ring resonators among the plurality of ring resonators, and the phase shifter is not provided in the other ring resonators.

9. The optical modulator according to claim 6, wherein the phase shifter is not provided in at least one ring resonator of the plurality of ring resonators.

10. The optical modulator according to claim 2, comprising a plurality of the optical waveguides.

11. The optical modulation device according to claim 2, further comprising a plurality of the ring resonators and a plurality of the optical waveguides, wherein
each of the plurality of ring resonators is optically coupled to at least two optical waveguides of the plurality of optical waveguides.

12. The optical modulator according to claim 2, wherein the optical waveguide includes a branch portion or a combining portion.

13. The optical modulator according to claim 2, wherein an end of the optical waveguide is connected to an optical amplifier.

14. The optical modulator according to claim 13, wherein the phase shifter is provided at a position of the optical waveguide between an optical coupling portion between the optical waveguide and the ring resonator and the optical amplifier.

15. The optical modulator according to claim 2, wherein a mirror is provided at an end of the optical waveguide.

16. The optical modulator according to claim 15, wherein the mirror is a Sagnac loop or a distributed Bragg reflector.

17. The optical modulator according to claim 2, wherein a Mach-Zehnder modulator is provided in the optical waveguide.

18. The optical modulator according to claim 2, wherein in the photonic crystal structure, a pore of a photonic crystal includes an air gap or a material having a refractive index different from a refractive index of a waveguide portion.

19. A light source device, comprising:
an optical amplifier; and
an optical modulator to which light from the optical amplifier is incident, wherein the optical modulator includes:
an optical waveguide;
a ring resonator optically coupled to the optical waveguide; and
a phase shifter provided in the ring resonator and/or the optical waveguide, and
at least the ring resonator among the ring resonator and the optical waveguide has a photonic crystal structure.

20. A distance measuring device, comprising:
an optical amplifier;
an optical modulator to which light from the optical amplifier is incident; and
a light receiving unit that receives light reflected by an object via the optical modulator, wherein
the optical modulator includes:
an optical waveguide;
a ring resonator optically coupled to the optical waveguide; and
a phase shifter provided in the ring resonator and/or the optical waveguide, and
at least the ring resonator among the ring resonator and the optical waveguide has a photonic crystal structure.

21. A resonator device, comprising:
an optical waveguide; and
a ring resonator optically coupled to the optical waveguide, wherein
at least the ring resonator among the ring resonator and the optical waveguide has a photonic crystal structure.
